(19) United States
(12) Patent Application Publication
(10) Pub. No.: US 2026/0093167 A1
(43) Pub. Date: Apr. 2, 2026

(54) SHIFT DEVICE AND PROJECTOR

(71) Applicant: SEIKO EPSON CORPORATION, Tokyo (JP)

(72) Inventors: Wataru TABATA, MATSUMOTO-SHI (JP); Tsuyoshi ARAI, INA-SHI (JP); Wataru KITAHARA, SHIOJIRI-SHI (JP); Masatoshi ITO, MATSUMOTO-SHI (JP)

(21) Appl. No.: 19/345,450

(22) Filed: Sep. 30, 2025

(30) Foreign Application Priority Data
Sep. 30, 2024 (JP) 2024-171217

(51) Int. Cl. G03B 21/14

(52) U.S. Cl. CPC G03B 21/142

(57) ABSTRACT

A shift device that moves a projection optical device configured to project an image in a first direction orthogonal to an optical axis of the projection optical device, the shift device including: a first movable member having a first reference portion and configured to move the projection optical device; a frame movably supporting the first movable member; a first drive unit configured to apply a first driving force to the first movable member to move the first movable member along the first direction; and a first regulating surface configured to regulate movement of the first movable member along the first direction by coming into contact with the first reference portion, in which the first movable member includes a first load region to which the first driving force acts from the first drive unit, and the first regulating surface and at least a part of the first load region are disposed on a same first virtual plane orthogonal to the optical axis.

The present application is based on, and claims priority from JP Application Serial Number 2024-171217, filed Sep. 30, 2024, the disclosure of which is hereby incorporated by reference herein in its entirety.

### BACKGROUND

### 1. Technical Field

The present disclosure relates to a shift device and a projector.

### 2. Related Art

In the related art, there is known a projector that includes a projection optical device that projects an image on a projection surface, and a projection position adjustment device that adjusts a projection position of the image by the projection optical device by shifting the projection optical device in a direction orthogonal to an optical axis of the projection optical device (for example, refer to JP-A-2015-184352).

In the projector described in JP-A-2015-184352, the projection position adjustment device includes a first movable member that can move in a left-right direction, a second movable member that can move in an upper-lower direction, a support member that supports the first movable member and the second movable member, a drive device and a

### TRANSMISSION DEVICE

The first movable member has a guide recessed portion, and a guide protrusion of the second movable member is inserted into the guide recessed portion to guide movement of the first movable member in the left-right direction. When a first dial implementing a first drive unit is rotated, a screw gear implementing a first transmission unit of the transmission device is rotated, and a slide member meshing with the screw gear moves along the left-right direction. As a result, the first movable member, which has the recessed portion into which an extension portion of the slide member is inserted, is moved in the left-right direction.

JP-A-2015-184352 is an example of the related art.

In the projection position adjustment device described in JP-A-2015-184352, if arrangement positions of the extension portion of the slide member and the recessed portion of the first movable member and arrangement positions of the guide protrusion and the guide recessed portion are misaligned with each other in the direction along a lens optical axis, when the first movable member is moved to an end in a moving direction, the first movable member may be inclined with respect to a plane orthogonal to the lens optical axis. In this case, there is a problem that the focus position of the image projected by the projection optical device is shifted, and the image displayed on the projection surface is deteriorated.

For this reason, there has been a demand for a configuration capable of preventing the inclination of the projection optical device with respect to a plane orthogonal to the optical axis.

### SUMMARY

A shift device according to a first aspect of the present disclosure is a shift device that moves a projection optical device configured to project an image in a first direction orthogonal to an optical axis of the projection optical device, the shift device including: a first movable member having a first reference portion and configured to move the projection optical device; a frame movably supporting the first movable member; a first drive unit configured to apply a first driving force to the first movable member to move the first movable member along the first direction; and a first regulating surface configured to regulate movement of the first movable member along the first direction by coming into contact with the first reference portion, in which the first movable member includes a first load region to which the first driving force acts from the first drive unit, and the first regulating surface and at least a part of the first load region are disposed on a same first virtual plane orthogonal to the optical axis.

A projector according to a second aspect of the present disclosure includes: a light source; a light modulation device configured to modulate light emitted from the light source; a projection optical device configured to project light modulated by the light modulation device; and the shift device according to the first aspect configured to move the projection optical device.

### BRIEF DESCRIPTION OF THE DRAWINGS

FIG. 1 is a perspective view showing an appearance of a projector according to an embodiment.

FIG. 2 is a schematic diagram showing a configuration of an image projection apparatus according to the embodiment.

FIG. 3 is a perspective view showing a projection optical device and a shift device according to the embodiment.

FIG. 4 is a perspective view showing the projection optical device and the shift device according to the embodiment.

FIG. 5 is a perspective view showing the shift device according to the embodiment.

FIG. 6 is a perspective view showing the shift device according to the embodiment.

FIG. 7 is an exploded perspective view showing the shift device according to the embodiment.

FIG. 8 is an exploded perspective view showing the shift device according to the embodiment.

FIG. 9 is an exploded perspective view showing a frame, a first movable member, and a second movable member in the embodiment.

FIG. 10 is an exploded perspective view showing the frame, the first movable member, and the second movable member in the embodiment.

FIG. 11 is a diagram showing the frame in the embodiment.

FIG. 12 is a diagram showing the first movable member in the embodiment.

FIG. 13 is a diagram showing the first movable member in the embodiment.

FIG. 14 is a diagram showing the second movable member in the embodiment.

FIG. 15 is a perspective view showing a first feed screw and a first meshing member in the embodiment.

FIG. 16 is a perspective view showing the first feed screw and the first meshing member in the embodiment.

FIG. 17 is a cross-sectional view showing the first feed screw and the first meshing member in the embodiment.

FIG. 18 is a cross-sectional view showing the shift device in the embodiment.

FIG. 19 is a cross-sectional view showing the frame and the first movable member in the embodiment.

FIG. 20 is a cross-sectional view showing a second feed screw and a second meshing member in the embodiment.

FIG. 21 is a cross-sectional view showing the shift device in the embodiment.

FIG. 22 is a cross-sectional view showing the shift device in the embodiment.

### DESCRIPTION OF EMBODIMENTS

Hereinafter, an embodiment of the present disclosure will be described with reference to the drawings.

### Schematic Configuration of Projector

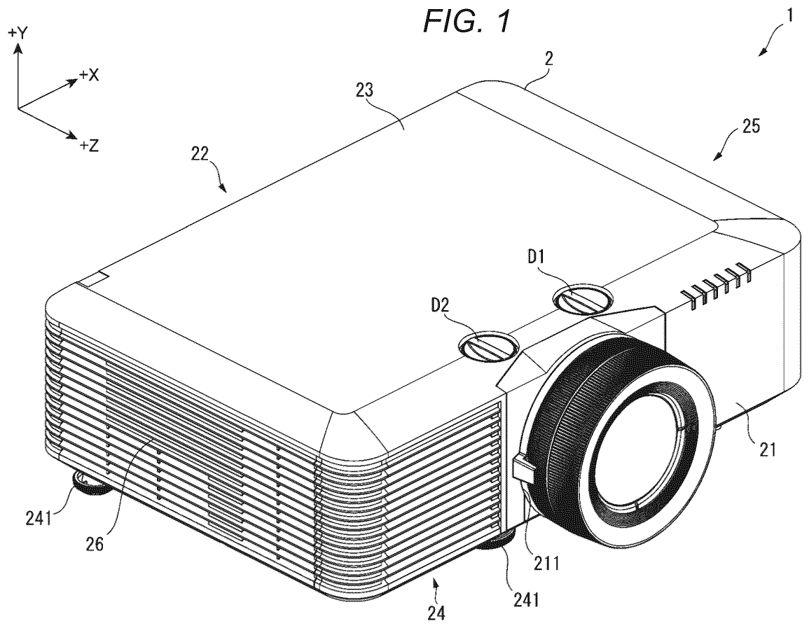

FIG. 1 is a perspective view showing an appearance of a projector 1 according to the embodiment.

The projector 1 according to the embodiment is a display device that modulates light emitted from a light source to form image light corresponding to an image signal, and projects the formed image light onto a projection surface. The projector 1 includes an exterior housing 2, as shown in FIG. 1.

### Configuration of Exterior Housing

The exterior housing 2 has a front surface portion 21, a rear surface portion 22, a top surface portion 23, a bottom surface portion 24, a right side surface portion 25, and a left side surface portion 26, and is formed in a substantially rectangular parallelepiped shape.

The front surface portion 21 has a projection opening 211. The projection opening 211 exposes a part of a projection optical device 36 of an image projection apparatus 3, which will be described later.

Two dials D1 and D2 for operating a shift device 4, which will be described later, are exposed to the top surface portion 23.

The bottom surface portion 24 is provided with a plurality of legs 241 that come into contact with an installation surface on which the projector 1 is installed.

### Configuration of Image Projection Apparatus

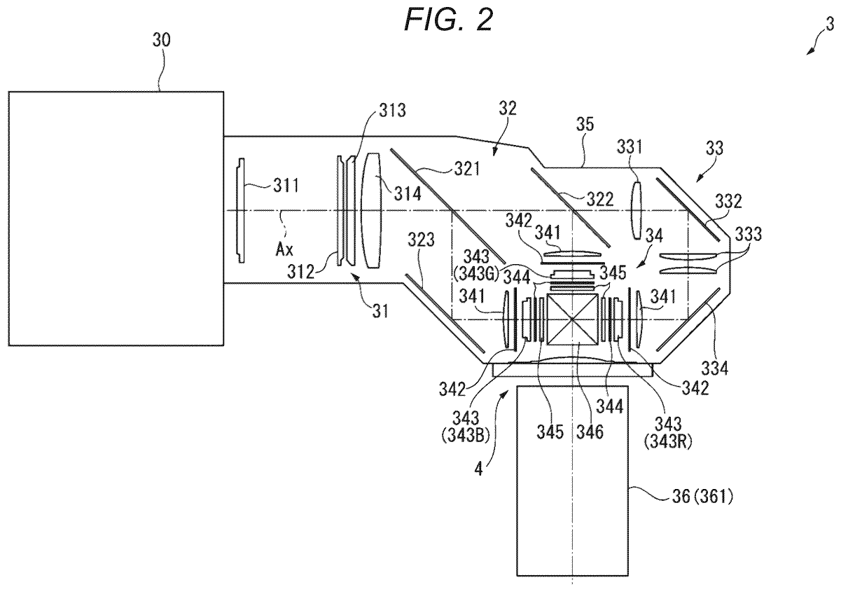

FIG. 2 is a schematic diagram showing a configuration of the image projection apparatus 3.

The projector 1 includes the image projection apparatus 3 accommodated in the exterior housing 2.

The image projection apparatus 3 projects image light corresponding to an image signal. As illustrated in FIG. 2, the image projection apparatus 3 includes a light source 30, a homogenizing device 31, a color separation device 32, a relay device 33, an image forming device 34, an optical component housing 35, a projection optical device 36, and the shift device 4.

The light source 30 emits light. Although not illustrated, the light source 30 includes a solid-state light-emitting element such as a laser diode (LD) and a wavelength conversion element that converts the wavelength of at least part of light emitted from the solid-state light-emitting element. The light source 30 may include a discharge light source lamp such as an ultra-high pressure mercury lamp.

The homogenizing device 31 homogenizes the illuminance distribution of the light emitted from the light source 30. The light having a uniform illuminance distribution passes through the color separation device 32 and the relay device 33, and illuminates a modulation region of a light modulation device 343, which will be described later, of the image forming device 34. The homogenizing device 31 includes two lens arrays 311 and 312, a polarization converter 313, and a superimposing lens 314.

The color separation device 32 separates the light incident from the homogenizing device 31 into red light, green light, and blue light. The color separation device 32 includes two dichroic mirrors 321 and 322 and a reflection mirror 323 that reflects the blue light separated by the dichroic mirror 321.

The relay device 33 is provided in the optical path of the red light, which is longer than the optical paths of the other color light, so as to reduce loss of the red light. The relay device 33 includes an incident side lens 331, a relay lens 333, and a reflection mirror 332,334. In the embodiment, the relay device 33 is provided on the optical path of the red light. However, the present disclosure is not limited thereto, and for example, a configuration may be adopted in which the color light having a longer optical path than the other color light is set as the blue light, and the relay device 33 is provided on the optical path of the blue light.

The image forming device 34 forms image light from light incident from the color separation device 32 and the relay device 33. Specifically, the image forming device 34 modulates the incident color lights of red, green, and blue light, and combines the modulated color light to form the image light. The image forming device 34 includes three field lenses 341, three incident side polarizing plates 342, three light modulation devices 343, three viewing angle compensation plates 344, and three emission side polarizing plates 345, which are provided according to the incident color light, and one color combining element 346.

The light modulation device 343 modulates the incident light according to an image signal. That is, the light modulation device 343 modulates the light emitted from the light source 30. The light modulation devices 343 include a light modulation device 343R for red light, a light modulation device 343G for green light, and a light modulation device 343B for blue light. In the embodiment, the light modulation device 343 is formed of a transmissive liquid crystal panel, and the incident side polarizing plate 342, the light modulation device 343, and the emission side polarizing plate 345 form a liquid crystal light valve.

The color combining element 346 combines the color lights modulated by the light modulation devices 343B, 343G, and 343R to form image light. In the embodiment, the color combining element 346 is formed of a cross dichroic prism, but is not limited to this and may also be formed, for example, of a plurality of dichroic mirrors.

The optical component housing 35 accommodates the above-described devices 31 to 34 therein. An illumination optical axis Ax, which is a design optical axis, is set in the image projection apparatus 3, and the optical component housing 35 holds the devices 31 to 34 at predetermined positions on the illumination optical axis Ax. The light source 30 and the projection optical device 36 are disposed at predetermined positions on the illumination optical axis Ax.

The projection optical device 36 is a projection lens that enlarges and projects the image light formed by the image forming device 34 onto a projection surface. That is, the projection optical device 36 projects the light modulated by the light modulation devices 343B, 343G, and 343R. The projection optical device 36 is configured as, for example, a lens assembly in which a plurality of lenses are accommodated in a cylindrical lens barrel 361.

### Configuration of Shift Device

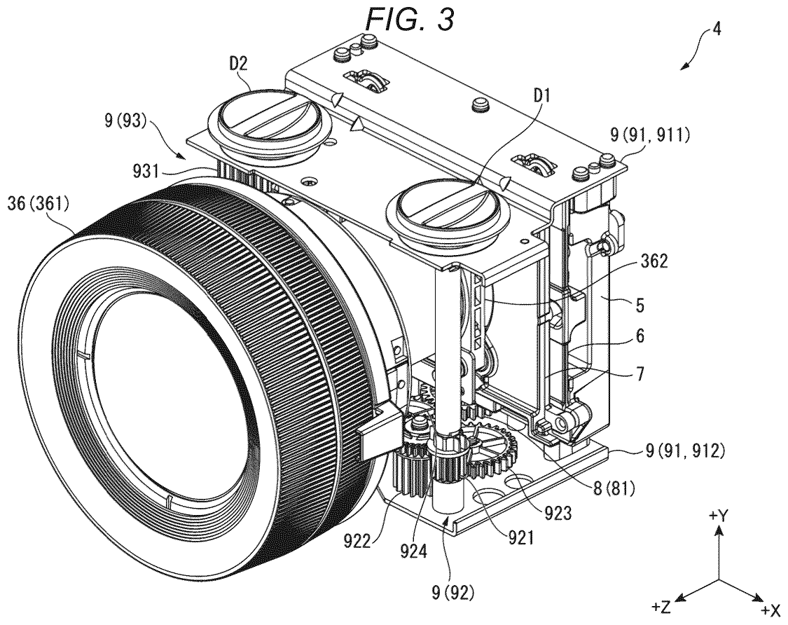

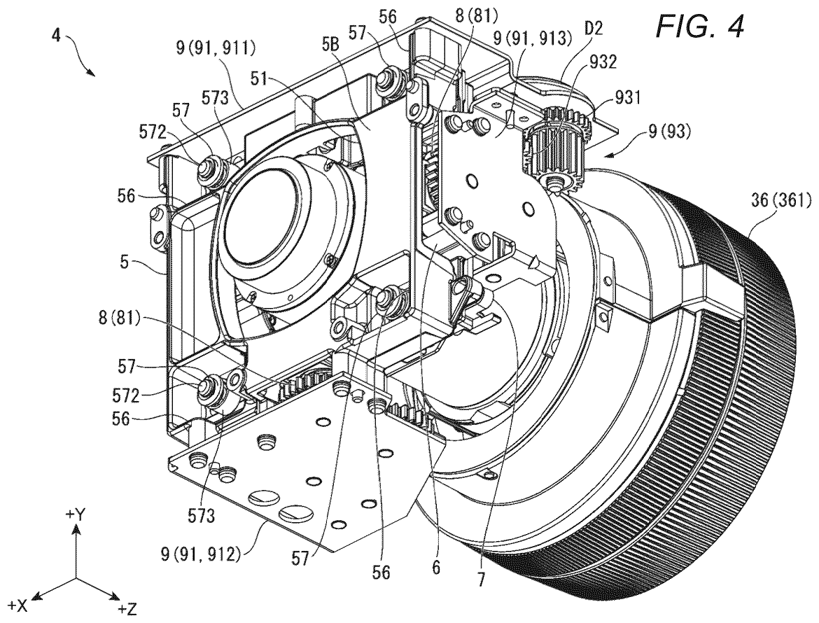

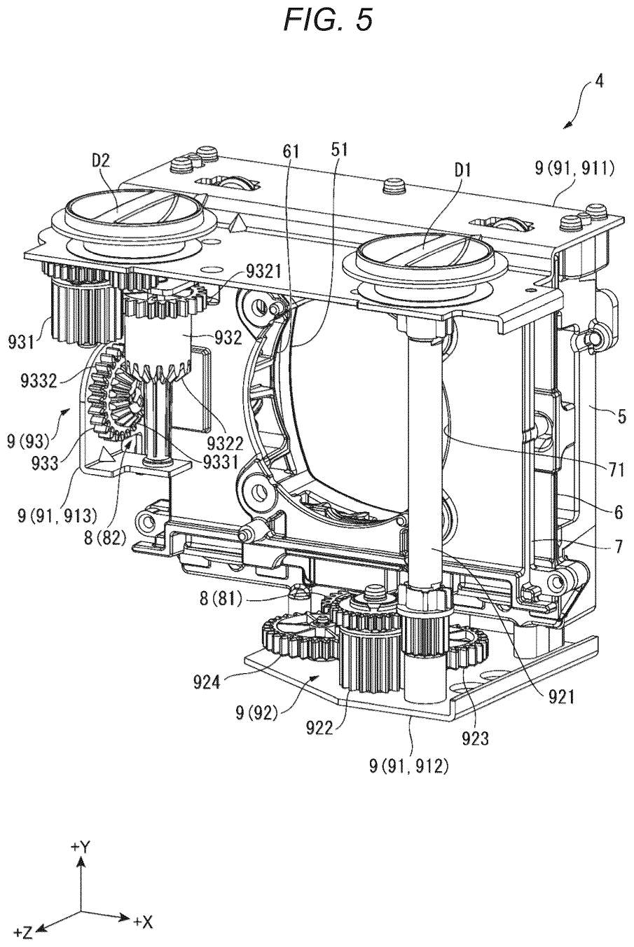

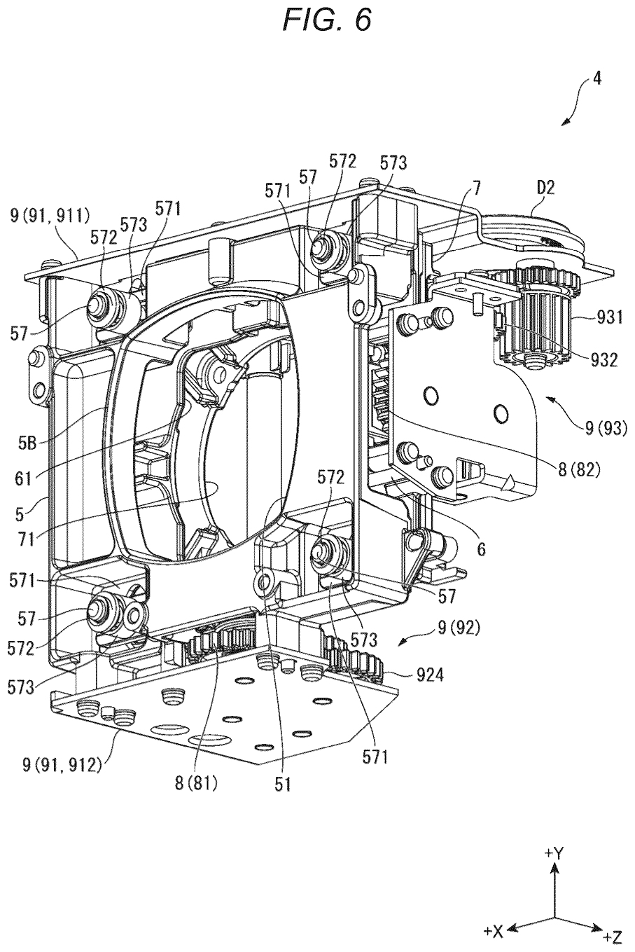

FIG. 3 is a perspective view illustrating the projection optical device 36 and the shift device 4 viewed from an emission side of the image light, and FIG. 4 is a perspective view illustrating the projection optical device 36 and the shift device 4 viewed from an incident side of the image light. FIGS. 5 and 6 are perspective views showing the shift device 4 while the projection optical device 36 is not shown. Specifically, FIG. 5 is a perspective view illustrating the shift device 4 viewed from the emission side of the image light, and FIG. 6 is a perspective view illustrating the shift device 4 viewed from the incident side of the image light.

The shift device 4 supports the lens barrel 361 of the projection optical device 36 and moves the projection optical device 36 in two directions orthogonal to a lens optical axis of the projection optical device 36.

As illustrated in FIGS. 3 to 6, the shift device 4 includes a frame 5, a first movable member 6, a second movable member 7, a drive device 8, a transmission device 9, and the dials D1 and D2.

In the following description, three directions perpendicular to one another are defined as a +X direction, a +Y direction, and a +Z direction. In the embodiment, the +Z direction is defined as a direction along the lens optical axis of the projection optical device 36. Specifically, the +Z direction is defined as a direction along which the image light travels along the lens optical axis of the projection optical device 36. The +X direction is the rightward direction when the shift device 4 is viewed from the light emission side, and the +Y direction is the upward direction when the shift device 4 is viewed from the light emission side. That is, the +Z direction is defined as the direction from the rear surface portion 22 toward the front surface portion 21, the +X direction is defined as the direction from the left side surface portion 26 toward the right side surface portion 25, and the +Y direction is defined as the direction from the bottom surface portion 24 toward the top surface portion 23.

Further, a direction opposite to the +Z direction is defined as −Z direction, a direction opposite to the +X direction is defined as −X direction, and a direction opposite to the +Y direction is defined as −Y direction.

Therefore, “viewing the shift device 4 from the +Z direction” is synonymous with “viewing the shift device 4 from the emission side of image light”, and “viewing the shift device 4 from the −Z direction” is synonymous with “viewing the shift device 4 from the incident side of image light”.

### Configuration of Dial

As described above, the dials D1 and D2 are exposed from the top surface portion 23 and receive the rotation operation around a rotation axis along the +Y direction. That is, the dials D1 and D2 are rotated by a user. The dials D1 and D2 are attached to the frame 5 by a first attachment member 911 of the transmission device 9, which will be described later.

The dial D1 applies a rotational force to the drive device 8 to shift the projection optical device 36 along the +Y direction.

The dial D2 applies a rotational force to the drive device 8 to shift the projection optical device 36 along the +X direction. The dial D2 is disposed in the −X direction with respect to the dial D1.

### Configuration of Transmission Device

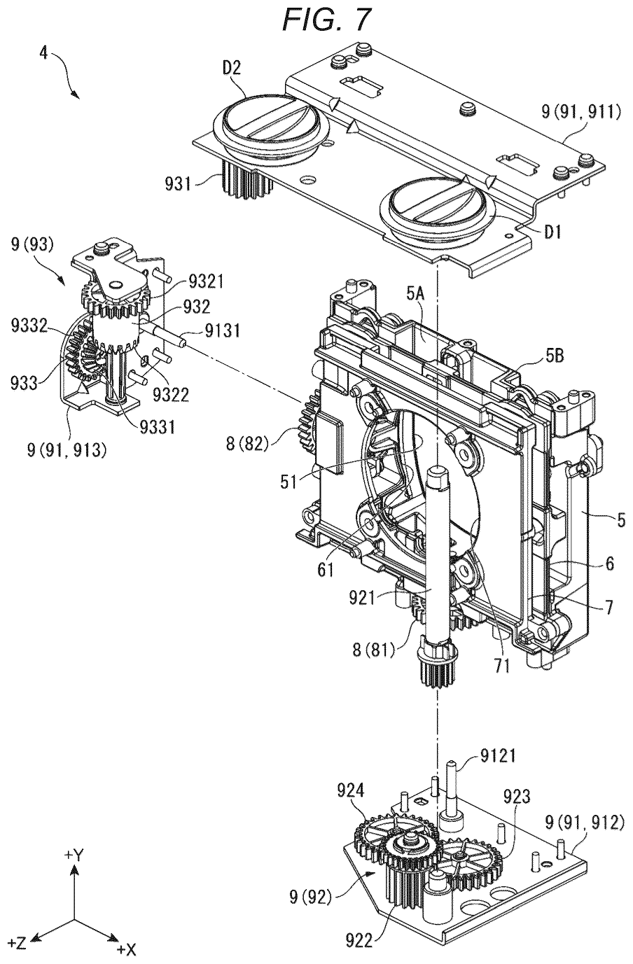

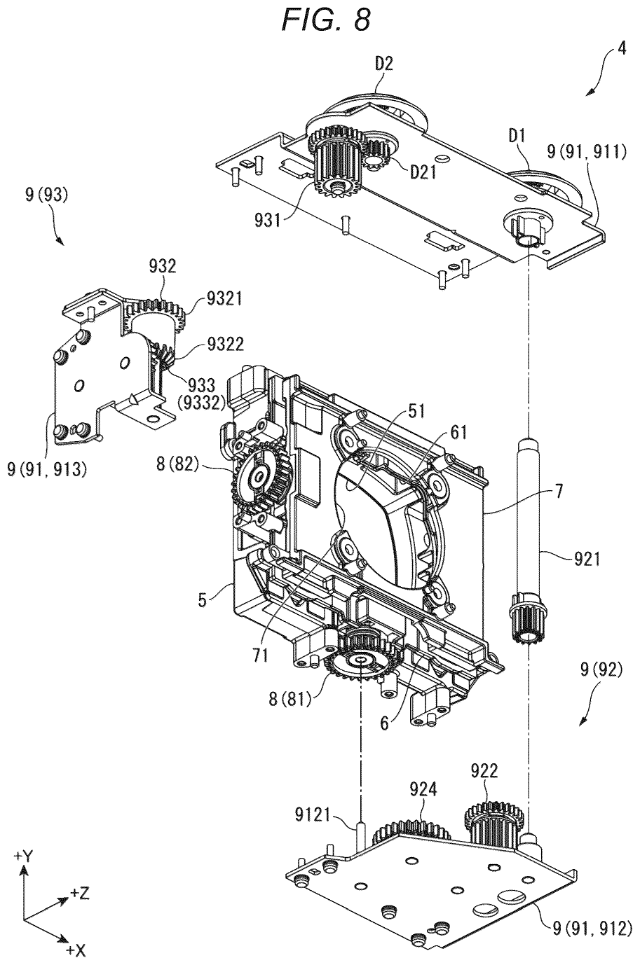

FIGS. 7 and 8 are exploded perspective views of the shift device 4 viewed from the +Z direction in a state where the dials D1 and D2 and the transmission device 9 are removed. Specifically, FIG. 7 is an exploded perspective view of the shift device 4 viewed from the +X direction and the +Y direction, and FIG. 8 is an exploded perspective view of the shift device 4 viewed from the −X direction and the −Y direction.

First, a configuration of the transmission device 9 will be described.

The transmission device 9 transmits the rotation of the dials D1 and D2 to the drive device 8. The transmission device 9 includes an attachment member 91, a first transmission unit 92, and a second transmission unit 93.

### Configuration of Attachment Member

The attachment member 91 supports the dials D1 and D2, the first transmission unit 92, and the second transmission unit 93, and is attached to the frame 5 or the first movable member 6. The attachment member 91 includes a first attachment member 911, a second attachment member 912, and a third attachment member 913. In the embodiment, each of the attachment members 911 to 913 is formed of a sheet metal.

The first attachment member 911 pivotally supports the dials D1 and D2 and a first gear 931 that forms the second transmission unit 93. The first attachment member 911 is fixed to a surface facing the +Y direction of the frame 5 which is substantially rectangular when viewed from the +Z direction.

The second attachment member 912 pivotally supports a shaft gear 921 and gears 922 to 924 that form the first transmission unit 92, and a first feed screw 81, which will be described later, of the drive device 8. That is, the second attachment member 912 has a pin-shaped support portion 9121 that supports the first feed screw 81 in a manner of being rotatable around the rotation axis along the +Y direction. The second attachment member 912 is fixed to a surface of the frame 5 facing the −Y direction.

The third attachment member 913 pivotally supports a second gear 932 and a third gear 933 that form the second transmission unit 93, and also pivotally supports a second feed screw 82, which will be described later, of the drive device 8. That is, the third attachment member 913 has a pin-shaped support portion 9131 that supports the second feed screw 82 in a manner of being rotatable around a rotation axis along the +X direction. The third attachment member 913 is fixed to a surface of the first movable member 6 facing the −X direction.

### Configuration of First Transmission Unit

The first transmission unit 92 transmits a rotational force of the dial D1 to the first feed screw 81 of the drive device 8, so that the first feed screw 81 is rotated according to a rotation operation of a user on the dial D1, and thus the projection optical device 36 is shifted along the +Y direction. The first transmission unit 92 includes the shaft gear 921, a first gear 922, a second gear 923, and a third gear 924. The shaft gear 921 and the gears 922 to 924 are reduction gears supported by the second attachment member 912 so as to be rotatable about the rotation axis along the +Y direction.

The shaft gear 921 is coupled to the dial D1 and rotates integrally with the dial D1.

The first gear 922 meshes with the shaft gear 921, the second gear 923 meshes with the first gear 922, and the third gear 924 meshes with the second gear 923 and the first feed screw 81.

In this way, the rotational force of the dial D1 is transmitted to the first feed screw 81 via the shaft gear 921 and the gears 922 to 924. As a result, the first feed screw 81 is rotated about the rotation axis along the +Y direction.

### Configuration of Second Transmission Unit

The second transmission unit 93 transmits a rotational force of the dial D2 to the second feed screw 82 of the drive device 8, so that the second feed screw 82 is rotated according to a rotation operation of a user on the dial D2, and thus the second movable member 7 and the projection optical device 36 are shifted along the +X direction. The second transmission unit 93 includes the first gear 931 pivotally supported by the first attachment member 911, and the second gear 932 and the third gear 933 which are pivotally supported by the third attachment member 913. The gears 931 to 933 form a reduction gear.

The first gear 931 is attached to a surface of the first attachment member 911 facing the −Y direction so as to be rotatable about the rotation axis along the +Y direction. As illustrated in FIG. 8, the first gear 931 meshes with a gear portion D21 provided at an end portion of the dial D2 in the −Y direction, and rotates with the rotation of the dial D2.

The second gear 932 is attached to the third attachment member 913 so as to be rotatable about the rotation axis along the +Y direction. The second gear 932 meshes with each of the first gear 931 and the third gear 933. Specifically, the second gear 932 is a two-stage gear having two meshing portions 9321 and 9322. The meshing portion 9321 meshes with the first gear 931, and the meshing portion 9322 meshes with the third gear 933.

The third gear 933 is attached to a surface of the third attachment member 913 facing the +X direction so as to be rotatable about the rotation axis along the +X direction. The third gear 933 meshes with each of the second gear 932 and the second feed screw 82, and the second feed screw 82 is rotated by the rotational force transmitted from the second gear 932. The third gear 933 is a two-stage gear having two meshing portions 9331 and 9332. The meshing portion 9331 meshes with the meshing portion 9322 of the second gear 932, and the meshing portion 9332 meshes with the second feed screw 82. In this way, the second gear 932 and the third gear 933 form a bevel gear that changes the rotation axis.

### Configuration of Frame

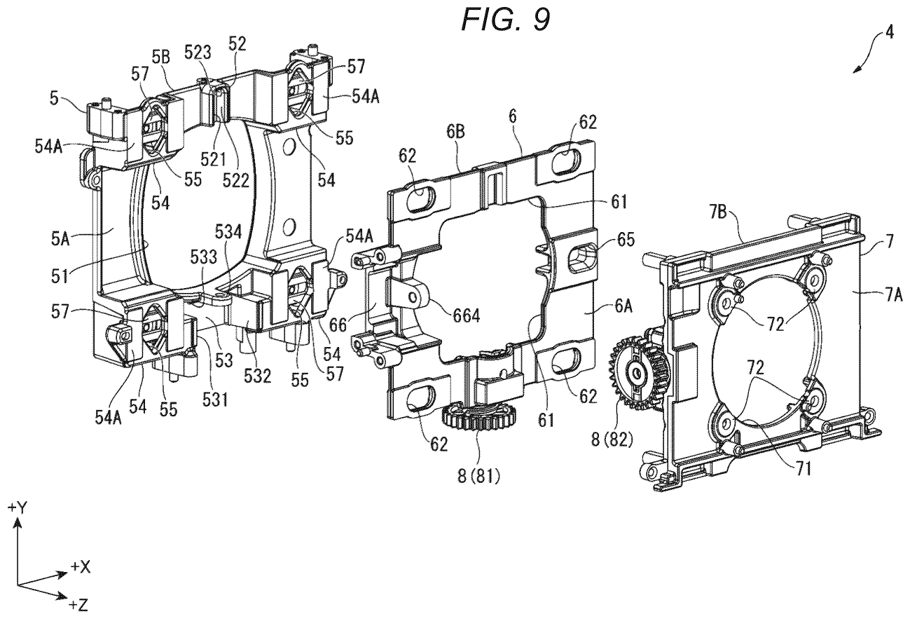

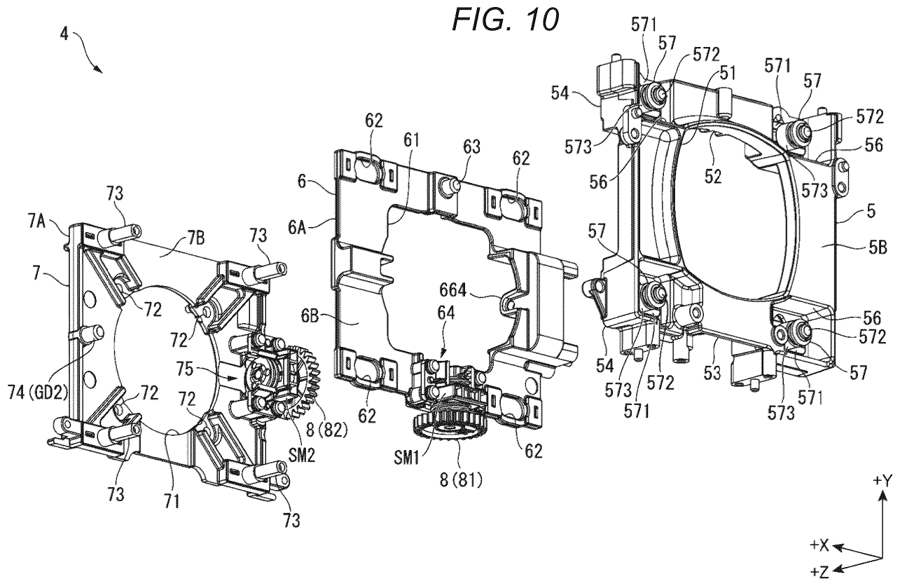

FIGS. 9 and 10 are exploded perspective views showing the frame 5, the first movable member 6, and the second movable member 7. Among these, FIG. 9 is an exploded perspective view illustrating the frame 5 and the like viewed from the +Z direction, and FIG. 10 is an exploded perspective view illustrating the frame 5 and the like viewed from the −Z direction. For convenience of description, the transmission device 9 and the dials D1 and D2 are not illustrated in FIGS. 9 and 10.

The frame 5 supports the first movable member 6, the second movable member 7, the drive device 8, the transmission device 9, and the dials D1 and D2. The frame 5 is formed in a rectangular shape when viewed from the +Z direction, and at least a part of the frame 5 overlaps the first movable member 6 and the second movable member 7 when viewed from the +Z direction.

As shown in FIGS. 9 and 10, the frame 5 is coupled to the second movable member 7 by a coupling member CM to be described later, and the first movable member 6 is sandwiched between the frame 5 and the second movable member 7.

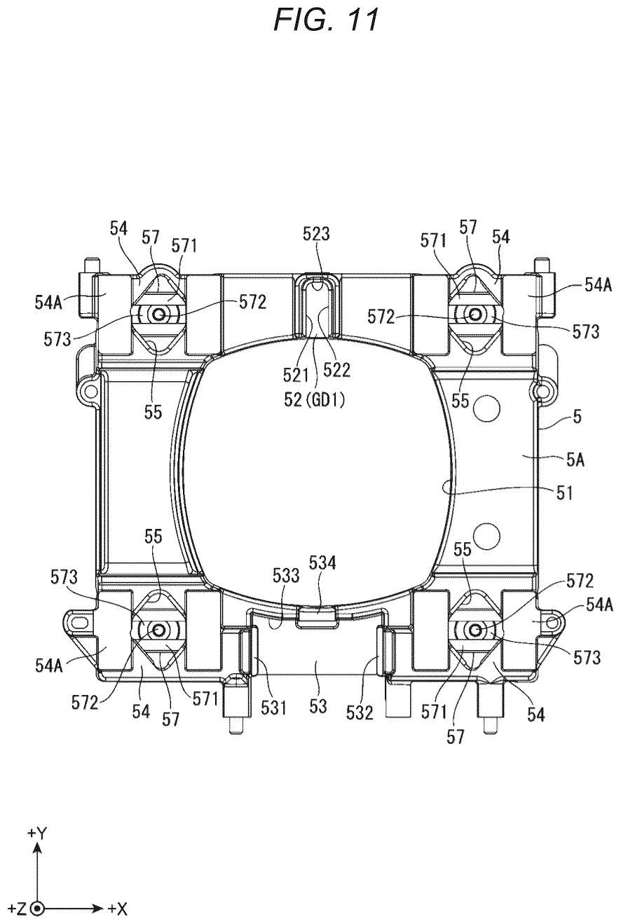

FIG. 11 is a diagram illustrating the frame 5 viewed from the +Z direction.

As shown in FIGS. 9 to 11, the frame 5 has an opening 51 through which the lens barrel 361 of the projection optical device 36 is inserted along the +Z direction at a substantially central portion. In addition, as illustrated in FIGS. 9 and 11, the frame 5 has a first guide groove 52, a first guide recessed portion 53, protruding portions 54, and through holes 55 which are provided on a first surface 5A facing the +Z direction.

As illustrated in FIG. 11, the first guide groove 52 is provided at a position in the +Y direction with respect to the opening 51, and extends along the +Y direction. The first guide groove 52, together with a first guide pin 63 (described later) of the first movable member 6 inserted into the first guide groove 52, forms a first guide portion GD1 that guides the movement of the first movable member 6 along the +Y direction. The first guide groove 52 is formed in a substantially U shape facing the −Y direction when viewed from the +Z direction. As shown in FIG. 11, the first guide groove 52 has a first inner surface 521 facing the +X direction, a second inner surface 522 facing the −X direction, and a third inner surface 523 facing the −Y direction.

The first inner surface 521 and the second inner surface 522 guide the movement along the +Y direction of the first guide pin 63 inserted into the first guide groove 52 from the +Z direction, and thus guide the movement of the first movable member 6 along the +Y direction.

The third inner surface 523 couples an end portion of the first inner surface 521 in the +Y direction and an end portion of the second inner surface 522 in the +Y direction. Instead of the through hole 55 described later, the third inner surface 523 may define a moving end of the first movable member 6 in the +Y direction. In this case, the movement of the first movable member 6 in the +Y direction may be restricted by the first guide pin 63 coming into contact with the third inner surface 523.

The first guide recessed portion 53 is provided at a position in the −Y direction with respect to the opening 51, and extends along the +Y direction. That is, the first guide recessed portion 53 is provided on a side opposite from the first guide groove 52 with the opening 51 interposed therebetween. The first guide recessed portion 53 has a first inner surface 531 facing the +X direction, a second inner surface 532 facing the −X direction, and a third inner surface 533 facing the −Y direction.

The first guide recessed portion 53 is recessed in the −Z direction to avoid a first meshing member SM1 and the first feed screw 81, and is also a recessed portion that guides the movement along the +Y direction of the first movable member 6 to which the first meshing member SM1 is fixed. Specifically, a part of the first movable member 6 is disposed between the first inner surface 531 and the second inner surface 532, and each inner surface 531, 532 guides the movement of the first movable member 6 along the +Y direction.

A support portion 534 stands in the +Z direction at a portion corresponding to a peripheral edge of the opening 51 in a bottom portion of the first guide recessed portion 53. The support portion 534 supports an end portion of the first feed screw 81 in the +Y direction in a manner of being rotatable about the rotation axis along the +Y direction.

As shown in FIGS. 9 and 11, the protruding portions 54 are provided at four corners of the rectangular first surface 5A and protrude in the +Z direction. That is, the frame 5 has four protruding portions 54. A surface 54A facing the +Z direction of each protruding portion 54 is a sliding surface on which the first movable member 6 slides, and is a regulating surface that regulates the rotation of the first movable member 6 about the rotation axis along the +Y direction. The rotation of the first movable member 6 about the rotation axis along the +Y direction is also restricted by a sliding surface of the second movable member 7 on which the first movable member 6 slides.

The through hole 55 is provided on the surface 54A of each protruding portion 54 and penetrates the protruding portion 54 along the +Z direction. An insertion pin 73 (to be described later) of the second movable member 7 is inserted into the through hole 55 in the −Z direction. An inner edge of the through hole 55 defines the moving end of the first movable member 6 along the +Y direction. That is, when the first movable member 6 moves in the +Y direction relative to the frame 5, the insertion pin 73 of the second movable member 7, which moves in the +Y direction integrally with the first movable member 6, comes into contact with a portion in the +Y direction of the inner edge of the through hole 55, and thus the movement of the second movable member 7 and ultimately the first movable member 6 in the +Y direction is restricted. Similarly, when the first movable member 6 moves in the −Y direction relative to the frame 5, the insertion pin 73 of the second movable member 7, which moves in the −Y direction integrally with the first movable member 6, comes into contact with a portion in the −Y direction of the inner edge of the through hole 55, and thus the movement of the second movable member 7 and ultimately the first movable member 6 in the −Y direction is restricted.

As illustrated in FIG. 10, the frame 5 has a second surface 5B facing the −Z direction and opposite to the first surface 5A. The frame 5 has recessed portions 56 provided in the second surface 5B and coupling members 57 disposed in the recessed portions 56.

The recessed portions 56 are respectively disposed at the four corners of the rectangular second surface 5B and are recessed in the +Z direction. That is, the frame 5 has four recessed portions 56, and each recessed portion 56 corresponds to the protruding portion 54.

The coupling member 57 is disposed in each recessed portion 56. The coupling member 57 is coupled to the insertion pin 73 inserted through the through hole 55, and maintains the interval between the frame 5, the first movable member 6, and the second movable member 7. The coupling member 57 includes a plate body 571, a screw pin 572, and a biasing member 573.

The plate body 571 is formed in a substantially rectangular shape that is long in the +X direction, and is disposed in the recessed portion 56 so as to be slidable along the +Y direction. The plate body 571 has a long hole that is long in the +X direction, and the screw pin 572 is inserted through the long hole along the +Z direction.

The screw pin 572 is inserted through the long hole of the plate body 571 and the through hole 55 in the +Z direction, and is fixed to the insertion pin 73 of the second movable member 7. As a result, the frame 5 and the second movable member 7 are coupled in a state where the first movable member 6 is sandwiched therebetween.

The biasing member 573 is interposed between the head of the screw pin 572 and the plate body 571. In the embodiment, the biasing member 573 is formed of a compression coil spring, and applies a biasing force to the head of the screw pin 572 and the plate body 571 in directions in which they move away from each other. The frame 5 and the first movable member 6 are pressed toward the second movable member 7 by the biasing force. Further, the head of the screw pin 572 is biased in a direction away from the second movable member 7 by the biasing force, so that the second movable member 7 to which the screw pin 572 is fixed is pulled toward the frame 5, and thus the second movable member 7 is pressed against the frame 5.

### Configuration of First Movable Member

The first movable member 6 is disposed in the +Z direction with respect to the frame 5, and is supported by the frame 5 so as to be movable along the +Y direction. Specifically, the frame 5, the first movable member 6, and the second movable member 7 are arranged in this order in the +Z direction, and the first movable member 6 is disposed between the frame 5 and the second movable member 7 in the +Z direction. That is, the first movable member 6 is disposed in the −Z direction with respect to the second movable member 7.

As shown in FIGS. 9 and 10, the first movable member 6 is formed in a substantially rectangular shape when viewed from the ±Z direction. The first movable member 6 has an opening 61 through which a part of the lens barrel 361 of the projection optical device 36 is inserted along the +Z direction, and through holes 62 provided at four corners of the first movable member 6. In addition, the first movable member 6 has a first surface 6A facing the +Z direction and a second surface 6B facing the −Z direction.

The through hole 62 penetrates the first movable member 6 along the +Z direction. The insertion pin of the second movable member 7 is inserted into the through hole 62 from the −Z direction. The surface surrounding the through hole 62 in the second surface 6B is a sliding surface that comes into contact with the surface 54A of the protruding portion 54 and slides along the surface 54A when the first movable member 6 moves along the +Y direction. The surface surrounding the through hole 62 in the first surface 6A is a sliding surface with which the second movable member 7 comes into contact and against which the second movable member 7 slides when the second movable member 7 moves along the +X direction.

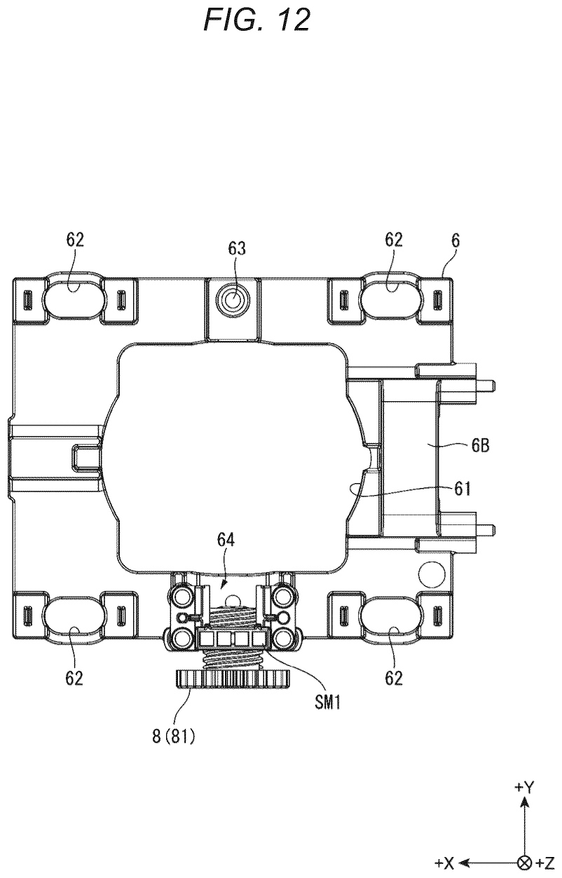

FIG. 12 is a diagram illustrating the first movable member 6 viewed from the −Z direction.

As shown in FIG. 12, the first movable member 6 includes the first guide pin 63 provided on the second surface 6B and a first arrangement portion 64 in which the first meshing member SM1 is arranged.

The first guide pin 63 is provided in a portion on the +Y direction with respect to the opening 61 and protrudes in the −Z direction. The first guide pin 63 is formed in a cylindrical shape when viewed from the −Z direction, and is inserted into the first guide groove 52 of the frame 5 from the −Z direction when the frame 5 and the first movable member 6 are combined. That is, the first guide pin 63, together with the first guide groove 52, forms the first guide portion GD1 that guides the movement of the first movable member 6 along the +Y direction.

The first arrangement portion 64 is provided on a side opposite from the first guide pin 63 with the opening 61 interposed therebetween. That is, the first arrangement portion 64 is provided at a portion in the −Y direction with respect to the opening 61. The first meshing member SM1 is arranged in the first arrangement portion 64. The first meshing member SM1 is fixed to the first arrangement portion 64 by a fixing member such as a screw.

The first meshing member SM1 will be described in detail later.

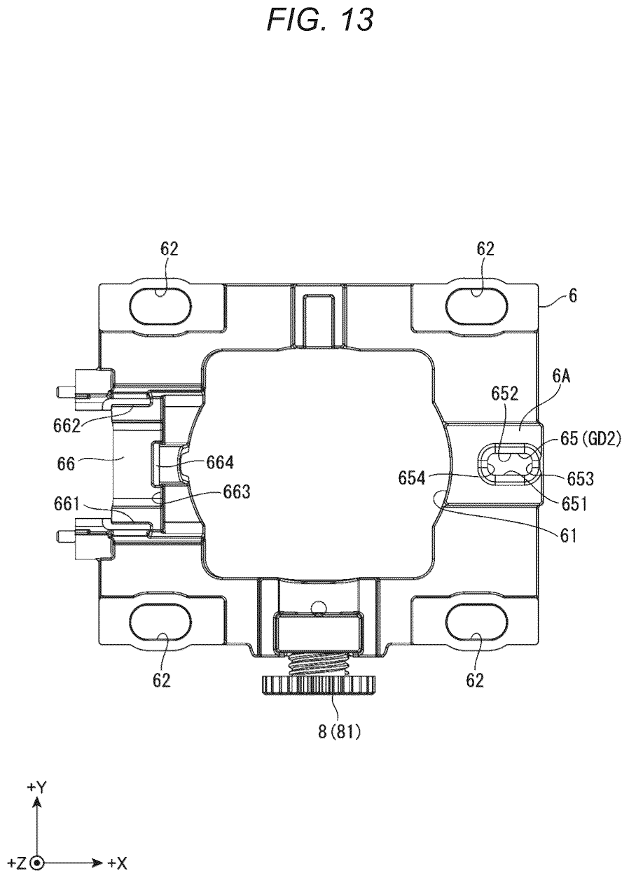

FIG. 13 is a diagram illustrating the first movable member 6 viewed from the +Z direction.

As shown in FIG. 13, the first movable member 6 has a second guide groove 65 and a second guide recessed portion 66 which are provided in the first surface 6A.

The second guide groove 65 is provided at a position in the +X direction with respect to the opening 61, and extends along the +X direction. The second guide groove 65, together with a second guide pin 74 (described later) of the second movable member 7 inserted into the second guide groove 65, forms a second guide portion GD2 that guides the movement of the second movable member 7 along the +X direction. The second guide groove 65 is formed in an elliptical shape that is long in the +X direction when viewed from the +Z direction. The second guide groove 65 has a first inner surface 651 facing the +Y direction, a second inner surface 652 facing the −Y direction, a third inner surface 653 facing the −X direction, and a fourth inner surface 654 facing the +X direction.

The first inner surface 651 and the second inner surface 652 guide the movement along the +X direction of the second guide pin 74 inserted into the second guide groove 65 from the +Z direction, and thus guide the movement of the second movable member 7 along the +X direction.

Each of the third inner surface 653 and the fourth inner surface 654 is a contact surface with which the second guide pin 74 can come into contact. The third inner surface 653 restricts the movement of the second guide pin 74 in the +X direction by coming into contact with the second guide pin 74 moved in the +X direction, and thus restricts the movement of the second movable member 7 in the +X direction. The fourth inner surface 654 restricts the movement of the second guide pin 74 in the −X direction by coming into contact with the second guide pin 74 moved in the −X direction, and thus restricts the movement of the second movable member 7 in the −X direction. That is, the third inner surface 653 and the fourth inner surface 654 define moving ends in a movement range of the second movable member 7 along the +X direction.

The second guide recessed portion 66 is provided at a position in the −X direction with respect to the opening 61, and extends along the +X direction. That is, the second guide recessed portion 66 is provided on a side opposite from the second guide groove 65 with the opening 61 interposed therebetween. The second guide recessed portion 66 has a first inner surface 661 facing the +Y direction, a second inner surface 662 facing the −Y direction, and a third inner surface 663 facing the −X direction.

The second guide recessed portion 66 is a recessed portion that avoids a second meshing member SM2 and the second feed screw 82, and also guides the movement along the +X direction of the second movable member 7 to which the second meshing member SM2 is fixed. Specifically, a part of the second movable member 7 is disposed between the first inner surface 661 and the second inner surface 662, and each inner surface 661, 662 guides the movement of the second movable member 7 along the +X direction.

A support portion 664 stands in the +Z direction at a portion corresponding to a peripheral edge of the opening 61 in a bottom portion of the second guide recessed portion 66. The support portion 664 supports an end portion of the second feed screw 82 in the +X direction in a manner of being rotatable about the rotation axis along the +X direction.

### Configuration of Second Movable Member

As illustrated in FIGS. 9 and 10, the second movable member 7 is disposed in the +Z direction with respect to the frame 5, and is coupled to the frame 5 by the coupling member 57. That is, the second movable member 7 is disposed furthest in the +Z direction among the frame 5, the first movable member 6, and the second movable member 7, and holds the lens barrel 361 of the projection optical device 36. The second movable member 7 has a first surface 7A facing the +Z direction and a second surface 7B facing the −Z direction, and has, at substantially the center, an opening 71 through which a part of the lens barrel 361 of the projection optical device 36 is inserted along the +Z direction.

As shown in FIG. 9, the second movable member 7 has a holder 72 that holds the lens barrel 361 around the opening 71. As shown in FIG. 3, the holder 72 holds a flange 362 provided on the lens barrel 361.

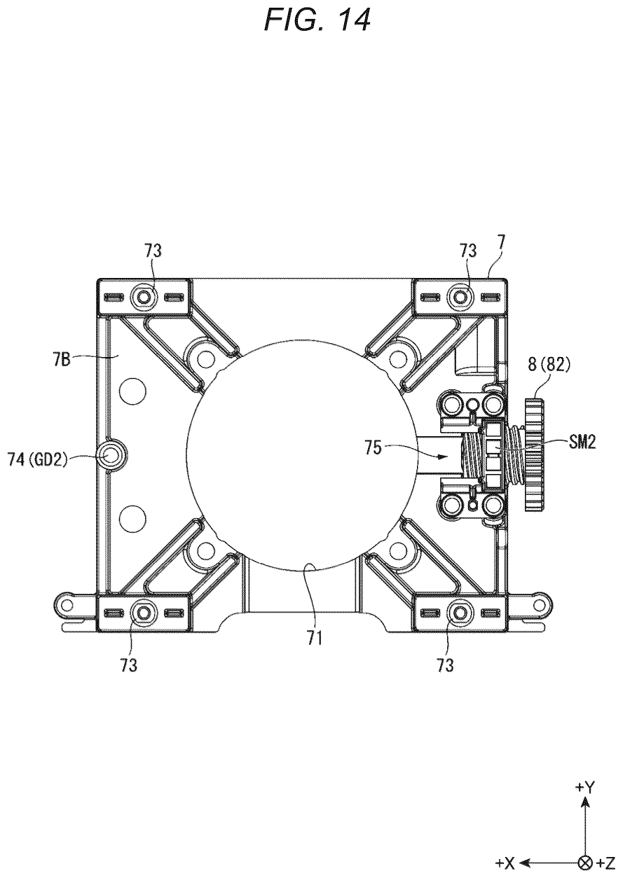

FIG. 14 is a diagram illustrating the second movable member 7 viewed from the −Z direction.

As illustrated in FIGS. 10 and 14, the second movable member 7 includes insertion pins 73, the second guide pin 74, and a second arrangement portion 75 which are provided on the second surface 7B.

The insertion pins 73 are respectively provided at the four corners of the second surface 7B of the second movable member 7, which is substantially rectangular. Each insertion pin 73 protrudes from the second surface 7B in the −Z direction. After each insertion pin 73 is inserted through the corresponding through hole 55, the screw pin 572 of the coupling member 57 described above is fixed to each of the insertion pins 73 from the −Z direction. The surface around the insertion pin 73 in the second surface 7B is a sliding surface that comes into contact with the surface around the through hole 62 in the first surface 6A of the first movable member 6 and slides along the surface around the through hole 62 when the second movable member 7 moves along the +X direction. The rotation of the second movable member 7 about the rotation axis along the +X direction is restricted by the surface around the insertion pin 73 in the second surface 7B and the surface around the corresponding through hole 62.

The second guide pin 74 is provided in a portion on the +X direction with respect to the opening 61 and protrudes in the −Z direction. The second guide pin 74 is formed in a cylindrical shape when viewed from the −Z direction, and is inserted into the second guide groove 65 of the first movable member 6 from the −Z direction when the first movable member 6 and the second movable member 7 are combined. That is, the second guide pin 74, together with the second guide groove 65, forms the second guide portion GD2 that guides the movement of the second movable member 7 along the +x direction.

The second arrangement portion 75 is provided on a side opposite from the first guide pin 63 with the opening 61 interposed therebetween. That is, the second arrangement portion 75 is provided at a portion in the −X direction with respect to the opening 61. The second meshing member SM2 is arranged in the second arrangement portion 75. The second meshing member SM2 is fixed to the second arrangement portion 75 by a fixing member such as a screw.

The second meshing member SM2 will be described in detail later.

### Configuration of Drive Device

The drive device 8 moves the first movable member 6 and the second movable member 7 by the rotational force transmitted from the transmission device 9. As shown in FIGS. 7 to 10, the drive device 8 includes the first feed screw 81 and the second feed screw 82.

### Configuration of First Feed Screw

The first feed screw 81 corresponds to a first drive unit. The first feed screw 81 is disposed between the second attachment member 912 illustrated in FIGS. 7 and 8 and the support portion 534 illustrated in FIG. 11, and is supported by the second attachment member 912 and the support portion 534 so as to be rotatable about the rotation axis along the +Y direction. The first feed screw 81 rotates about the rotation axis by the rotational force of the dial D1 transmitted by the first transmission unit 92. The first feed screw 81 meshes with the first meshing member SM1 and moves, along the +Y direction, the first movable member 6 to which the first meshing member SM1 is coupled.

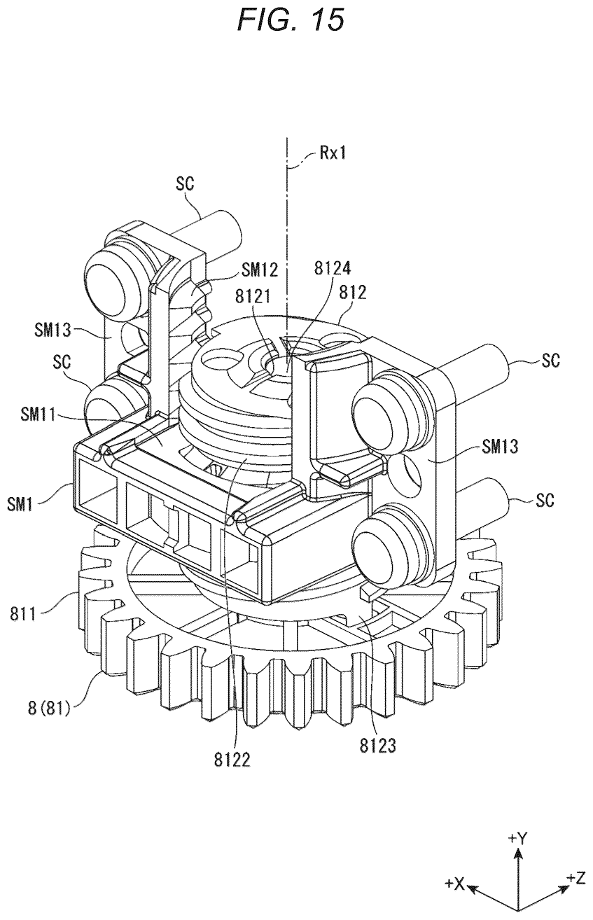

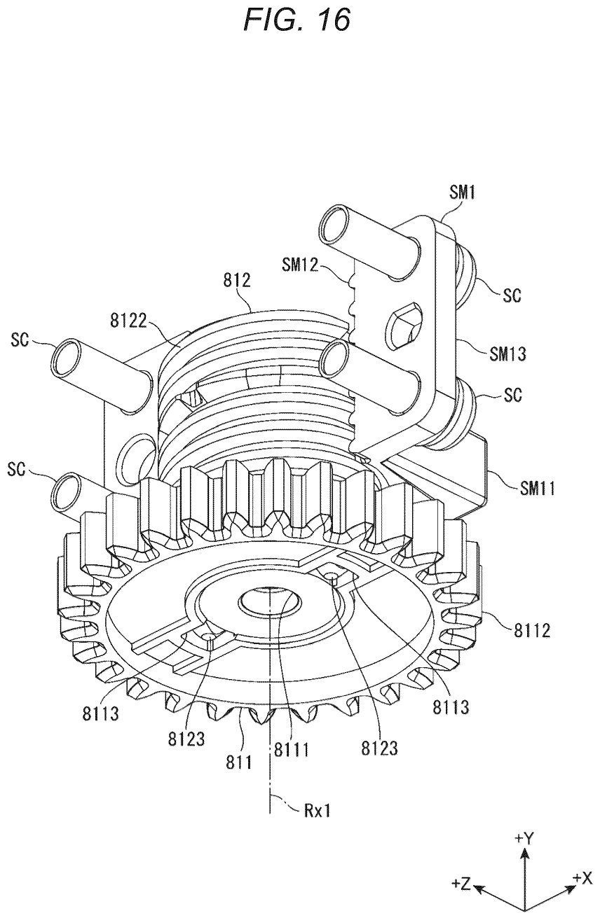

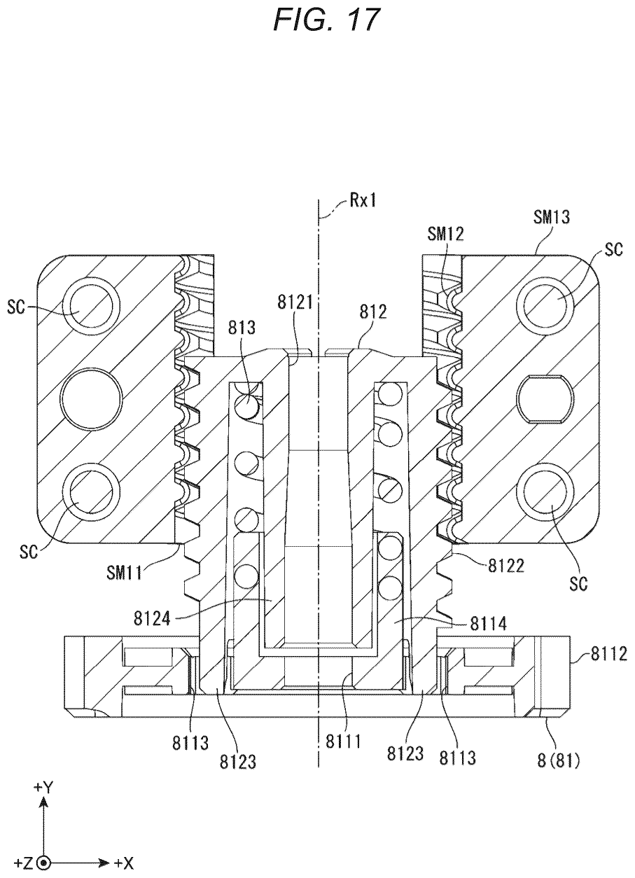

FIG. 15 is a perspective view of the first feed screw 81 forming the drive device 8 and the first meshing member SM1 as viewed from the +Y direction, and FIG. 16 is a perspective view of the first feed screw 81 and the first meshing member SM1 as viewed from the −Y direction. FIG. 17 is a view showing a cross section of the first feed screw 81 and the first meshing member SM1 along an XY plane.

As shown in FIGS. 15 to 17, the first feed screw 81 includes a first gear 811 and a second gear 812, as well as a biasing member 813 as shown in FIG. 17, and is implemented by combining these.

The first gear 811 is a gear that meshes with the third gear 924 of the first transmission unit 92. The first gear 811 includes a hole 8111, a meshing portion 8112, openings 8113, and a protruding portion 8114.

The hole 8111 is a hole into which the support portion 9121 provided on the second attachment member 912 is inserted. As a result, the first gear 811 is supported by the second attachment member 912 so as to be rotatable about a rotation axis R×1 along the +Y direction.

The meshing portion 8112 is provided on an outer peripheral surface of the first gear 811 centered on the rotation axis R×1, and meshes with the third gear 924.

The openings 8113 are provided at two positions sandwiching the protruding portion 8114 in a direction orthogonal to the rotation axis R×1, and each opening 8113 passes through the first gear 811 along the +Y direction. Insertion portions 8123 of the second gear 812 are inserted into the openings 8113.

As illustrated in FIG. 17, the protruding portion 8114 is a portion protruding in the +Y direction from the periphery of the hole 8111, and is formed in a cylindrical shape with a bottom. The protruding portion 8114 is inserted into the second gear 812 when the first gear 811 and the second gear 812 are combined.

The second gear 812 is a tubular body disposed in the +Y direction with respect to the first gear 811, and is combined with the first gear 811. That is, the second gear 812 rotates about the rotation axis R×1 integrally with the first gear 811. An end portion of the second gear 812 opposite from the first gear 811, that is, the end portion in the +Y direction is supported by the support portion 534.

The second gear 812 includes an insertion opening 8121, a meshing portion 8122, the insertion portions 8123, and an internal boss 8124.

The insertion opening 8121 penetrates the second gear 812 along the +Y direction. The insertion opening 8121 communicates with the hole 8111, and the support portion 9121 is inserted into the insertion opening 8121.

The meshing portion 8122 is formed by helical teeth provided on an outer peripheral surface centered on the rotation axis R×1. The meshing portion 8122 meshes with a meshing portion SM11 described later of the first meshing member SM1.

The insertion portion 8123 protrudes in the −Y direction from an end surface of the second gear 812 in the −Y direction. The insertion portions 8123 are provided at two positions sandwiching the insertion opening 8121, and each insertion portion 8123 is inserted into the corresponding opening 8113. Accordingly, the second gear 812 rotates integrally with the first gear 811.

The internal boss 8124 is a tubular portion that protrudes in the −Y direction from the end portion of the second gear 812 in the +Y direction, and surrounds the insertion opening 8121. The internal boss 8124 is inserted into the protruding portion 8114 when the first gear 811 and the second gear 812 are combined.

As illustrated in FIG. 17, the biasing member 813 is disposed inside the second gear 812 and applies a biasing force to the first gear 811 and the second gear 812 in directions in which they move away from each other.

In the embodiment, the biasing member 813 is formed of a compression coil spring, and one end of the biasing member 813 comes into contact with an end portion of the protruding portion 8114 of the first gear 811 in the +Y direction. The other end of the biasing member 813 comes into contact with an inner surface of the second gear 812 from which the internal boss 8124 protrudes in the −Y direction.

### Configuration of First Meshing Member

The first meshing member SM1 meshes with the first feed screw 81 and is fixed to the first arrangement portion 64 of the first movable member 6 by a screw SC. That is, the first meshing member SM1 is a part of the first movable member 6. As shown in FIGS. 15 to 17, the first meshing member SM1 includes the meshing portion SM11 and a pair of fixing portions SM13 that sandwich the meshing portion SM11.

The meshing portion SM11 has an arc-shaped meshing surface SM12 that covers half of the outer periphery of the second gear 812 in a circumferential direction, and the meshing surface SM12 is formed with a plurality of teeth that mesh with the helical teeth of the meshing portion 8122. That is, the meshing portion SM11 meshes with the meshing portion 8122 of the second gear 812. Therefore, the meshing portion SM11 can be said to be a load region where a driving force is applied from the first feed screw 81 to move the first movable member 6 along the +Y direction.

Of the pair of fixing portions SM13, one fixing portion SM13 extends in the +X direction from an end portion of the meshing portion SM11 in the +X direction, and the other fixing portion SM13 extends in the −X direction from an end portion of the meshing portion SM11 in the −X direction. The pair of fixing portions SM13 are fixed to the first arrangement portion 64 by a plurality of screws SC, so that the first meshing member SM1 is fixed to the first movable member 6.

When the dial D1 is rotated, the first feed screw 81 is rotated via the first transmission unit 92. Accordingly, the first movable member 6 to which the first meshing member SM1 that meshes with the first feed screw 81 is fixed is moved in a direction along a rotation axis of the first feed screw 81, that is, in the +Y direction.

Positional Relationship between First Feed Screw and First Guide Portion

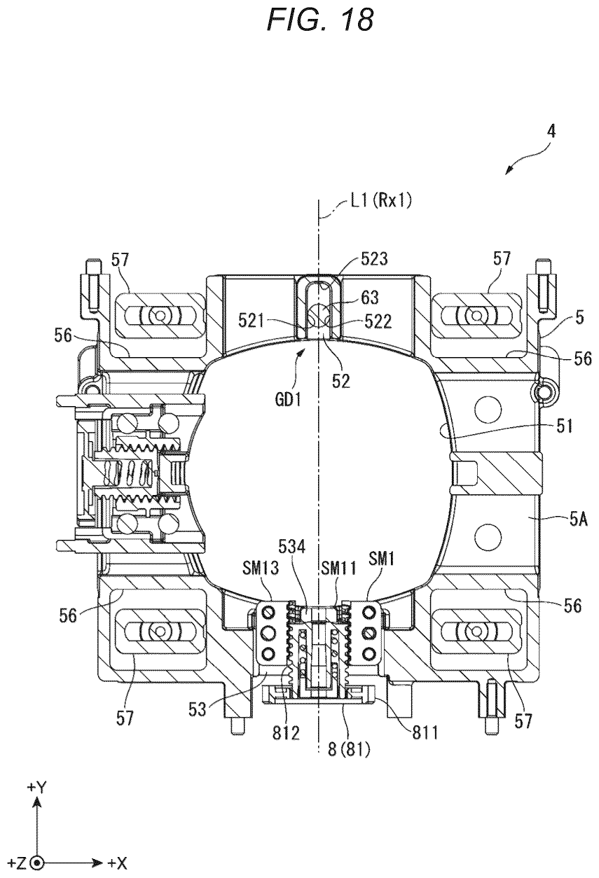

FIG. 18 is a diagram illustrating a cross section of the shift device 4 along the XY plane. Specifically, FIG. 18 is a diagram illustrating the cross section of the shift device 4 along the XY plane passing through the center of the first feed screw 81 in the +Z direction.

Hereinafter, a positional relationship between the first feed screw 81 and the first guide portion GD1 will be described.

In the embodiment, the first feed screw 81 serving as the first drive unit, and the first guide portion GD1 formed by the first guide pin 63 and the first guide groove 52 are disposed on an imaginary straight line L1 along the +Y direction, which is a first direction, with the opening 51 interposed therebetween. That is, the first feed screw 81, and the first guide pin 63 and the first guide groove 52 are disposed on the same imaginary straight line L1 along the +Y direction with the opening 51 interposed therebetween when viewed from the ±Z direction.

The imaginary straight line L1 corresponds to a first straight line, is an imaginary line positioned between the first inner surface 521 and the second inner surface 522 of the first guide groove 52, and in this embodiment, coincides with the rotation axis of the first feed screw 81.

Here, when the first feed screw 81, and the first guide pin 63 and the first guide groove 52 are not disposed on the same imaginary straight line L1 along the +Y direction, if a driving force is applied by the first feed screw 81 to move the first movable member 6 along the +Y direction, a rotational moment is generated that rotates the first movable member 6 about a contact portion between the first guide pin 63 and the first guide groove 52. In such a case, there is a possibility that the first movable member 6 does not move straight along the +Y direction, but moves while tilting with respect to the +Y direction. In such a case, the movement of the projection optical device 36 by the shift device 4 may cause a projection position of an image to shift from a position desired by the user.

In contrast, in the embodiment, the first feed screw 81, and the first guide pin 63 and the first guide groove 52 are disposed on the same imaginary straight line L1 along the +Y direction. According to this, it is possible to prevent the occurrence of the rotational moment described above. Therefore, the skew of the first movable member 6 with respect to the +Y direction can be prevented, and it is possible to prevent the projection position of the image from being shifted.

### Positional Relationship between Meshing Portion as Load Region in First Movable Member and Third Inner Surface as Regulating Surface

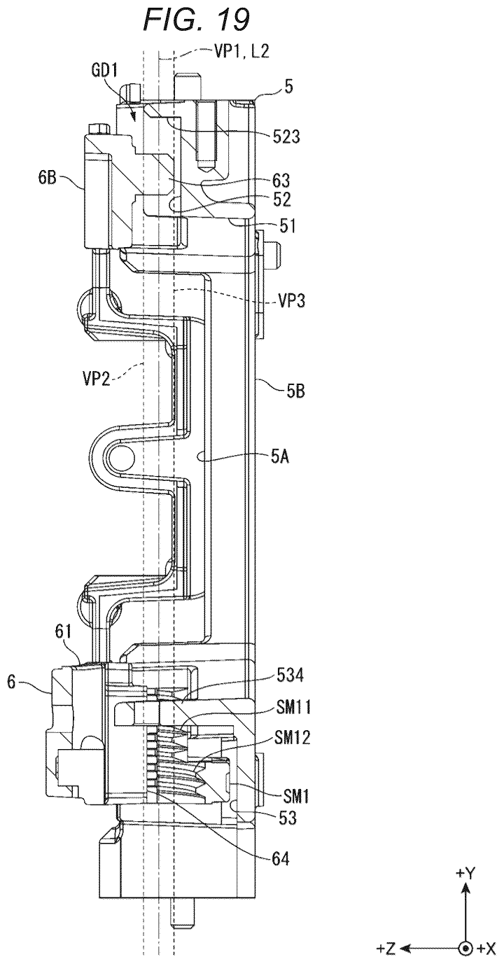

FIG. 19 is a view illustrating a cross section of the frame 5 and the first movable member 6 along a YZ plane, and is a view illustrating a positional relationship between the meshing portion SM11 of the first meshing member SM1 and the third inner surface 523 forming the first guide portion GD1. In FIG. 19, the first feed screw 81 is not shown.

In the embodiment, moving ends of the first movable member 6 in the ±Y direction are defined by the inner edge of the through hole 55 through which the insertion pin 73 of the second movable member 7 that moves integrally with the first movable member 6 in the ±Y direction is inserted. In this regard, as described above, the movement of the first movable member 6 in the +Y direction may be restricted by the first guide pin 63 of the first movable member 6 coming into contact with the third inner surface 523 forming the first guide groove 52 of the frame 5. The positional relationship between the third inner surface 523 as a first regulating surface and at least a part of the meshing portion SM11 as a first load region in this case will be described.

In the embodiment, as shown in FIG. 19, the third inner surface 523 as the first regulating surface and at least a part of the meshing portion SM11 as the first load region to which a driving force is applied from the first feed screw 81 in the first meshing member SM1 are disposed on a same virtual plane VP1 orthogonal to the +Z direction. That is, the third inner surface 523 and at least a part of the meshing portion SM11 are disposed on the same virtual plane VP1 orthogonal to the optical axis of the projection optical device 36.

Further, the first guide pin 63 as a first reference portion, the third inner surface 523, and at least a part of the meshing portion SM11 are disposed on an imaginary straight line L2 along the +Y direction.

The virtual plane VP1 is located between an end portion located closer to the −Z direction among an end portion of the first guide pin 63 in the +Z direction and an end portion of the third inner surface 523 in the +Z direction, and an end portion located closer to the +Z direction among an end portion of the first guide pin 63 in the −Z direction and an end portion of the third inner surface 523 in the −Z direction. The +Z direction corresponds to a first optical axis direction along the optical axis of the projection optical device 36, and the −Z direction corresponds to a second optical axis direction along the optical axis of the projection optical device 36.

In the embodiment, the virtual plane VP1 is located between the end portion of the third inner surface 523 in the +Z direction and the end portion of the first guide pin 63 in the −Z direction. That is, the virtual plane VP1 is disposed between a virtual plane VP2 that passes through the end portion of the third inner surface 523 in the +Z direction and orthogonal to the +Z direction and a virtual plane VP3 that passes through the end portion of the first guide pin 63 in the −Z direction and orthogonal to the +Z direction.

Here, when the first guide pin 63, the third inner surface 523, and the meshing portion SM11 are not on the same plane, for example, if the first movable member 6 moves in the +Y direction and the first movable member 6 tries to move further in the +Y direction from a state where the first guide pin 63 is in contact with the third inner surface 523, a rotational moment for tilting the first movable member 6 with respect to a plane orthogonal to the optical axis of the projection optical device 36 is generated around a contact portion between the first guide pin 63 and the third inner surface 523. When the rotational moment causes the first movable member 6 to tilt with respect to the plane orthogonal to the optical axis of the projection optical device 36, the focus position of an image projected by the projection optical device 36 is shifted, and the projected image is deteriorated.

On the other hand, in the embodiment, the first guide pin 63, the third inner surface 523, and at least a part of the meshing portion SM11 are located on the same virtual plane VP1. Therefore, even if the first movable member 6 further moves in the +Y direction from the state where the first guide pin 63 is in contact with the third inner surface 523, it is possible to prevent the generation of the rotational moment. Therefore, deterioration of the projected image can be reduced.

A part of the insertion pin 73, a part of a peripheral edge of the through hole 55 in the ±Y direction, and at least a part of the meshing portion SM11 may be disposed on the same virtual plane orthogonal to the optical axis of the projection optical device 36.

### Configuration of Second Feed Screw and Second Meshing Member

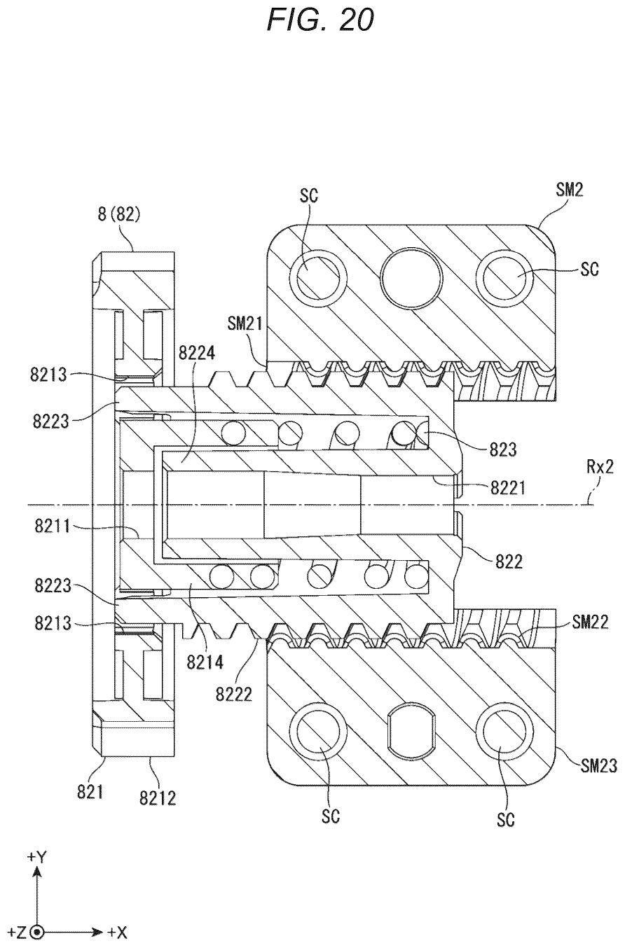

FIG. 20 is a view showing a cross section of the second feed screw 82 and the second meshing member SM2 along the XY plane.

As shown in FIG. 20, the second feed screw 82 as a second drive unit is rotatable about a rotation axis R×2 along the +X direction, and has the same configuration and function as the first feed screw 81. That is, the second feed screw 82 includes a first gear 821, a second gear 822, and a biasing member 823 which are similar to the first gear 811, the second gear 812, and the biasing member 813.

The first gear 821 has a hole 8211, a meshing portion 8212, an opening 8213, and a protruding portion 8214 which are similar to the hole 8111, the meshing portion 8112, the opening 8113, and the protruding portion 8114. The second gear 822 has an insertion opening 8221, a meshing portion 8222, an insertion portion 8223, and an internal boss 8224 which are similar to the insertion opening 8121, the meshing portion 8122, the insertion portion 8123, and the internal boss 8124.

The second meshing member SM2 has the same configuration and function as the first meshing member SM1, and is fixed to the second arrangement portion 75 of the second movable member 7. That is, the second meshing member SM2 has a meshing portion SM21, a meshing surface SM22, and a pair of fixing portions SM23 which are similar to the meshing portion SM11, the meshing surface SM12, and the pair of fixing portions SM13.

When the dial D2 is rotated, the second feed screw 82 is rotated via the second transmission unit 93. Accordingly, the second movable member 7 to which the second meshing member SM2 that meshes with the second feed screw 82 is fixed is moved in a direction along a rotation axis of the second feed screw 82, that is, in the +X direction. At this time, the second movable member 7 moves along the first movable member 6, and therefore, the member against which the second movable member 7 slides can be said to be the first movable member 6 supported by the frame 5.

### Positional Relationship between Second Feed Screw and Second Guide Portion

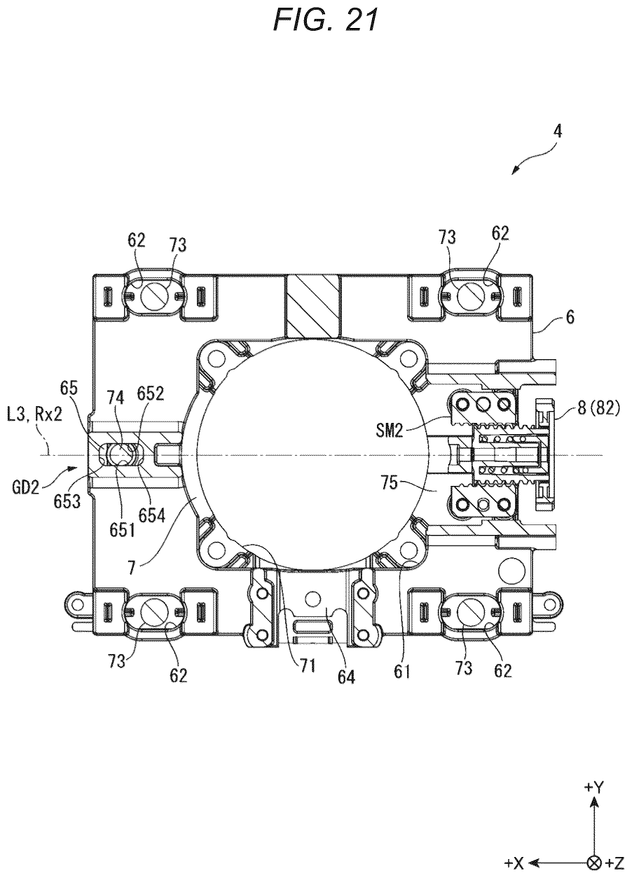

FIG. 21 is a diagram illustrating a cross section of the shift device 4 along the XY plane. Specifically, FIG. 21 is a diagram illustrating the cross section of the shift device 4 along the XY plane passing through the center of the second feed screw 82 in the +Z direction.

As illustrated in FIG. 21, the second feed screw 82 serving as the second drive unit, and the second guide portion GD2 formed by the second guide pin 74 and the second guide groove 65 are disposed on an imaginary straight line L3 along the +X direction, which is a second direction, with the opening 61 interposed therebetween. That is, the second feed screw 82 and the second guide portion GD2 are disposed on the same imaginary straight line L3 along the +X direction. The imaginary straight line L3 corresponds to a second straight line, is an imaginary line positioned between the first inner surface 651 and the second inner surface 652 of the second guide groove 65, and in this embodiment, coincides with the rotation axis R×2 of the second feed screw 82.

Positional Relationship between Meshing Portion as Load Region in Second Movable Member and Third Inner Surface as Regulating Surface

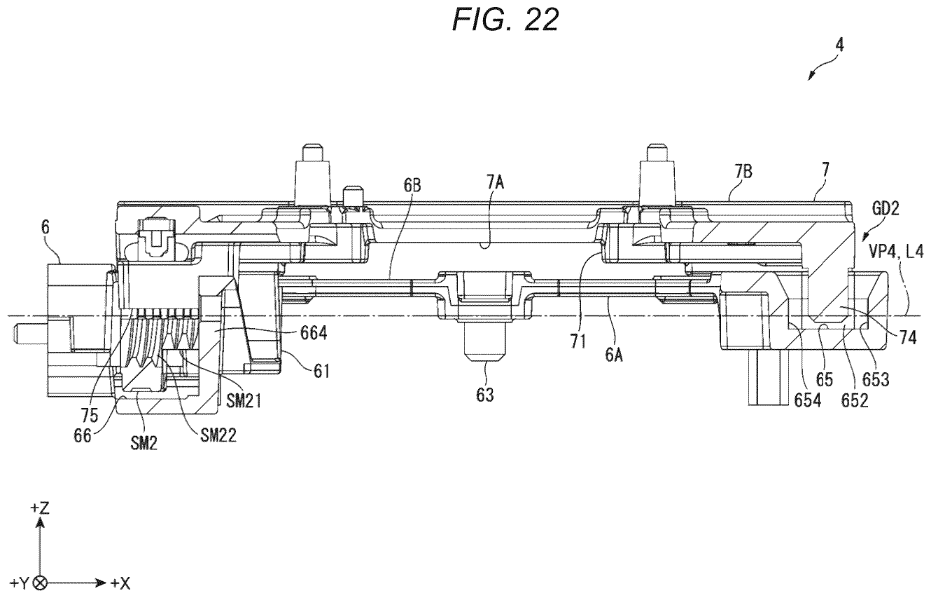

FIG. 22 is a view illustrating a cross section of the first movable member 6 and the second movable member 7 along an XZ plane, and is a view illustrating a positional relationship between the meshing portion SM21 of the second meshing member SM2 and the third inner surface 653 forming the second guide portion GD2. In FIG. 22, the second feed screw 82 is not shown.

As shown in FIG. 22, the third inner surface 653 serving as the first regulating surface and at least a part of the meshing portion SM21 serving as a second load region to which a driving force is applied from the second feed screw 82 in the second meshing member SM2 are disposed on a same virtual plane VP4 orthogonal to the +Z direction. That is, the third inner surface 653 and at least a part of the meshing portion SM21 are disposed on the same virtual plane VP4 orthogonal to the optical axis of the projection optical device 36.

Further, the second guide pin 74 as a second reference portion, the third inner surface 653 that defines the moving end of the second movable member 7 in the +X direction, and at least a part of the meshing portion SM21 are disposed on the imaginary straight line L4 along the +X direction.

In the embodiment, the second guide pin 74, the fourth inner surface 654 defining a moving end of the second movable member 7 in the −X direction, and at least a part of the meshing portion SM21 are disposed on the same virtual plane VP4 orthogonal to the +Z direction, and further disposed on the imaginary straight line L4 along the +X direction.

### Effects of Embodiment

The projector 1 according to the present embodiment described above provides the advantages below.

The projector 1 includes the light source 30, the light modulation device 343 that modulates the light emitted from the light source 30, the projection optical device 36 that projects the light modulated by the light modulation device 343, and the shift device 4 that moves the projection optical device 36.

The shift device 4 is a shift device that moves the projection optical device 36 that projects an image in the +X direction and the +Y direction that are orthogonal to the optical axis of the projection optical device 36 and are orthogonal to each other. The +X direction is one of the first direction and the second direction, and the +Y direction is the other of the first direction and the second direction. The direction along the optical axis is the +Z direction.

The shift device 4 includes the frame 5, the first movable member 6, the first feed screw 81, and the third inner surface 523.

The first movable member 6 has the first guide pin 63 as the first reference portion, and causes the projection optical device 36 to move.

The frame 5 movably supports the first movable member 6.

The first feed screw 81 corresponds to the first drive unit. The first feed screw 81 applies to the first movable member 6 a first driving force for moving the first movable member 6 along the +Y direction.

The third inner surface 523 corresponds to the first regulating surface. The third inner surface 523 restricts the movement of the first movable member 6 along the +Y direction by coming into contact with the first guide pin 63. In the embodiment, the third inner surface 523 is provided on the frame 5.

The first movable member 6 includes the first meshing member SM1. The meshing portion SM11 of the first meshing member SM1 corresponds to the first load region where the first driving force is applied from the first feed screw 81.

The third inner surface 523 and at least a part of the first meshing portion SM11 are disposed on the same virtual plane VP1 orthogonal to the optical axis. The virtual plane VP1 corresponds to a first virtual plane.

The shift device 4 further includes the second movable member 7, the second feed screw 82, and the third inner surface 653.

When the second movable member 7 functions as the first movable member of the present disclosure, the second movable member 7 has the second guide pin 74 as the first reference portion, and causes the projection optical device 36 to move.

The frame 5 movably supports the second movable member 7.

The second feed screw 82 corresponds to the first drive unit when the second movable member 7 functions as the first movable member of the present disclosure. The second feed screw 82 applies to the second movable member 7 a driving force for moving the second movable member 7 along the +X direction.

The third inner surface 653 corresponds to the first regulating surface when the second movable member 7 functions as the first movable member of the present disclosure. The third inner surface 653 restricts the movement of the second movable member 7 along the +X direction by coming into contact with the second guide pin 74. In the embodiment, the third inner surface 653 is provided on the first movable member 6.

The second movable member 7 includes the second meshing member SM2. The meshing portion SM21 of the second meshing member SM2 corresponds to the first load region where the driving force is applied from the second feed screw 82 when the second movable member 7 functions as the first movable member of the present disclosure.

The third inner surface 653 and at least a part of the first meshing portion SM21 are disposed on the same virtual plane VP4 orthogonal to the optical axis. The virtual plane VP4 corresponds to a first virtual plane.

According to such a configuration, the third inner surface 523 and the meshing portion SM11 are disposed on the same virtual plane VP1, so that even when the first driving force is applied to the meshing portion SM11 and the first movable member 6 moves along the +Y direction, it is possible to prevent the generation of the rotational moment that rotates the first movable member 6 in the direction inclined with respect to an orthogonal plane orthogonal to the optical axis of the projection optical device 36. Therefore, it is possible to suppress a change in the focus position of an image projected by the projection optical device 36, and therefore, it is possible to prevent the deterioration of the image projected by the projection optical device 36.

Further, when the second movable member 7 functions as the first movable member of the present disclosure, the third inner surface 653 and the meshing portion SM21 are disposed on the same virtual plane VP4, so that even when the driving force is applied to the meshing portion SM21 and the second movable member 7 moves along the +X direction, it is possible to prevent the generation of the rotational moment that rotates the second movable member 7 in the direction inclined with respect to an orthogonal plane orthogonal to the optical axis of the projection optical device 36. Therefore, it is possible to suppress a change in the focus position of an image projected by the projection optical device 36, and therefore, it is possible to prevent the the deterioration of the image projected by the projection optical device 36.

In the shift device 4, as illustrated in FIG. 19, the virtual plane VP1 is located between the end portion located closer to the −Z direction among the end portion of the first guide pin 63 in the +Z direction and the end portion of the third inner surface 523 in the +Z direction, and the end portion located closer to the +Z direction among the end portion of the first guide pin 63 in the −Z direction and the end portion of the third inner surface 523 in the −Z direction. The +Z direction along the optical axis corresponds to the first optical axis direction, and the −Z direction corresponds to the second optical axis direction.

By positioning the third inner surface 523 as the first regulating surface and at least a part of the meshing portion SM11 as the first load region on the virtual plane VP1 disposed at such a position, the generation of the rotational moment can be prevented. Therefore, a change in the focus position of an image projected by the projection optical device 36 can be reduced, and the deterioration of the projected image can be prevented.

The same applies when the virtual plane VP4 is set in the same manner as the virtual plane VP1.

In the shift device 4, the first guide pin 63 serving as the first reference portion, the third inner surface 523 serving as the first regulating surface, and at least a part of the meshing portion SM11 serving as the first load region are disposed on the imaginary straight line L2 along the +Y direction. The imaginary straight line L2 corresponds to an imaginary first straight line.

According to such a configuration, the first guide pin 63 can be brought into contact with the third inner surface 523 along the +Y direction in which the first driving force is applied to the meshing portion SM11. Therefore, when the first guide pin 63 is in contact with the third inner surface 523, it is possible to prevent generation of not only the rotational moment that tilts the first movable member 6 with respect to the optical axis orthogonal plane, but also the rotational moment that rotates the first movable member 6 within the optical axis orthogonal plane. Therefore, the first movable member 6 can be stably moved along the +Y direction, and thus the projection optical device 36 can be stably moved along the +Y direction.

In the embodiment, the second guide pin 74, the third inner surface 653, and at least a part of the meshing portion SM21 are disposed on the imaginary straight line L4 along the +X direction. Therefore, similarly to the above, the second movable member 7 can be stably moved along the +X direction, and thus the projection optical device 36 can be stably moved along the +X direction.

In the shift device 4, the first feed screw 81 serving as the first drive unit is provided on the second attachment member 912 attached to the frame 5 so as to be rotatable about the rotation axis R×1 along the +Y direction. That is, the first feed screw 81 is provided on the frame 5. The first feed screw 81 applies the first driving force to the first movable member 6 by rotating about the rotation axis R×1.

The imaginary straight line L2 coincides with the rotation axis R×1 of the first feed screw 81.

According to such a configuration, when the first feed screw 81 is rotated and the first movable member 6 moves along the +Y direction, the generation of the rotational moment described above can be prevented.

The second feed screw 82 is provided on the third attachment member 913 attached to the first movable member 6 supported by the frame 5 so as to be rotatable about the rotation axis R×2 along the +X direction. The second feed screw 82 applies a driving force to the second movable member 7 by rotating about the rotation axis R×2. The imaginary straight line L4 coincides with the rotation axis R×2 of the second feed screw 82.

According to such a configuration, it is possible to prevent the rotational moment from acting on the second movable member 7.

In the shift device 4, the first feed screw 81 includes the first gear 811, the second gear 812, and the biasing member 813. A rotational force for rotating the first feed screw 81 is transmitted to the first gear 811. The second gear 812 rotates integrally with the first gear 811. An outer peripheral surface of the second gear 812 is provided with helical teeth along the +Y direction, and the second gear 812 meshes with the first movable member 6 via the first meshing member SM1. The biasing member 813 is provided between the first gear 811 and the second gear 812, and biases the second gear 812 in a direction away from the first gear 811 along the +Y direction.

According to such a configuration, the occurrence of rattling between the first feed screw 81, and the support portion 534 and the second attachment member 912 can be prevented, and the second gear 812 of the first feed screw 81 and the first meshing member SM1 can be easily brought into contact with each other. Thus, idle rotation of the dial D1 can be reduced, and therefore the projection optical device 36 can be moved in response to the operation on the dial D1. Accordingly, the operability of the shift device 4 can be enhanced.

In addition, since the biasing member 813 is provided inside the first feed screw 81, the size of the shift device 4 along the +Y direction can be reduced as compared with a case in which the biasing member is provided at a position where the biasing force for maintaining a contact state between the second gear 812 and the first meshing member SM1 acts on the entire first feed screw 81. Accordingly, the size of the shift device 4 can be reduced.

The second feed screw 82, which is disposed between the support portion 664 and the third attachment member 913 and meshes with the second meshing member SM2, also a configuration similar to that of the first feed screw 81. Therefore, the second feed screw 82 can also achieve the same effect as described above.

The shift device 4 includes the first guide portion GD1 that guides the movement of the first movable member 6 along the +Y direction. The first guide portion GD1 includes the first guide pin 63 provided on one of the frame 5 and the first movable member 6, and the first guide groove 52 provided on the other of the frame 5 and the first movable member 6, extending in the +Y direction, and in which the first guide pin 63 is disposed. In the embodiment, the first guide pin 63 is provided on the first movable member 6, and the first guide groove 52 is provided on the frame 5. The first guide pin 63 is disposed in the first guide groove 52 so as to be movable along the +Y direction.

According to such a configuration, the first movable member 6 can be smoothly moved along the +Y direction by the first guide portion GD1. In addition, since the first guide portion GD1 can be formed by the first guide pin 63 and the first guide groove 52, the first guide portion GD1 can be simply formed.

The second guide portion GD2 having the same configuration as the first guide portion GD1 can also provide the same effect to the second movable member 7.

In the shift device 4, the first guide pin 63 is provided on the first movable member 6, and the first guide groove 52 is provided on the frame 5. The first reference portion is the first guide pin 63, and the first regulating surface is the third inner surface 523 that intersects with the +Y direction in the first guide groove 52.

According to such a configuration, compared to a case where the first reference portion is provided separately from the first guide pin 63 and the first regulating surface is provided separately from the first guide groove 52, the configuration of the shift device 4 can be simplified, and the size of the shift device 4 in the +Y direction can be reduced.

In the shift device 4, the second guide pin 74 is provided in the second movable member 7, and the second guide groove 65 is provided in the first movable member 6 supported by the frame 5. When the second movable member 7 functions as the first movable member of the present disclosure, the first reference portion is the second guide pin 74, and the first regulating surface is at least one of the third inner surface 653 and the fourth inner surface 654 that intersects with the +Y direction in the second guide groove 65.

Even with such a configuration, the same effects as described above can be achieved.

In the shift device 4, the frame 5 has the opening 51 through which the projection optical device 36 is inserted. The first feed screw 81 serving as the first drive unit and the first guide portion GD1 are disposed on opposite sides from each other with the opening 51 interposed therebetween.

According to such a configuration, a distance between the first feed screw 81 and the first guide portion GD1 can be increased. Therefore, as compared with a case where a distance between the first feed screw 81 and the first guide portion GD1 is short, the linear movement stability of the first movable member 6 can be improved.

In addition, the second feed screw 82 and the second guide portion GD2 are provided on opposite sides from each other with the opening 61 of the first movable member 6 interposed therebetween, so that the linear movement stability of the second movable member 7 can be improved as described above.

The shift device 4 includes the second movable member 7, the second feed screw 82, the third inner surface 653, and the fourth inner surface 654.

The second movable member 7 has the second guide pin 74 serving as the second reference portion, and moves the projection optical device 36 along the +X direction. The +X direction corresponds to the second direction.

The second feed screw 82 corresponds to the second drive unit. The second feed screw 82 applies to the second movable member 7 a second driving force for moving the second movable member 7 along the +X direction.

The third inner surface 653 and the fourth inner surface 654 correspond to a second regulating surface. The third inner surface 653 restricts the movement of the second movable member 7 in the +X direction by coming into contact with the second guide pin 74. The fourth inner surface 654 restricts the movement of the second movable member 7 in the −X direction by coming into contact with the second guide pin 74. That is, each inner surface 653, 654 restricts the movement of the second movable member 7 along the +X direction by coming into contact with the second guide pin 74.

The second movable member 7 includes the second meshing member SM2, and the meshing portion SM21 in the second meshing member SM2 corresponds to the second load region where the second driving force acts from the second feed screw 82. As illustrated in FIG. 22, the third inner surface 653, the fourth inner surface 654, and at least a part of the meshing portion SM21 are disposed on the same virtual plane VP4 orthogonal to the optical axis of the projection optical device 36. The virtual plane VP4 corresponds to a second virtual plane.

According to such a configuration, as with the first movable member 6, it is possible to prevent the generation of the rotational moment that rotates the second movable member 7 in the direction inclined with respect to the orthogonal plane orthogonal to the optical axis of the projection optical device 36. Therefore, it is possible to suppress a change in the focus position of an image projected by the projection optical device 36, and therefore, it is possible to prevent the the deterioration of the image projected by the projection optical device 36.

### Modifications of Embodiment

The present disclosure is not limited to the embodiments described above, and variations, improvements, and other modifications to the extent that the advantage of the present disclosure is achieved fall within the scope of the present disclosure.

In the above embodiment, the shift device 4 includes the dials D1 and D2 to be operated by the user, and the rotational force of the dials D1 and D2 is transmitted to each of the feed screws 81 and 82 of the drive device 8. That is, the projection optical device 36 is manually moved. However, the shift device according to the present disclosure is not limited thereto, and the projection optical device 36 may be shifted electrically.

In the above embodiment, the first guide portion GD1 is formed by the first guide pin 63 and the first guide groove 52, and the second guide portion GD2 is formed by the second guide pin 74 and the second guide groove 65. However, the configuration of the guide portions is not limited to the above as long as movement of the movable members can be guided. For example, the guide portion may be formed by a rib and a groove, or a guide portion and a biasing portion may be integrated together like a dovetail groove. Further, the movement of each of the movable members 6 and 7 may be guided by a rail slider.

In the above embodiment, the movement of the first movable member 6 is guided not only by the first guide portion GD1 but also by the first guide recessed portion 53 of the frame 5, and the movement of the second movable member 7 is guided not only by the second guide portion GD2 but also by the second guide recessed portion 66 of the first movable member 6. That is, there are two configurations for guiding the movement of the movable member. However, the number of configurations for guiding the movement of the movable member is not limited thereto, and may be one or three or more. For example, when the shift device 4 includes only the first guide portion GD1 as a configuration for guiding the movement of the first movable member 6, a length of the first guide groove 52 in the +Y direction may be increased. Further, the first guide recessed portion 53 may restrict the rotation of the first movable member 6 about the rotation axis along the +Y direction, and the second guide recessed portion 66 may restrict the rotation of the second movable member 7 about the rotation axis along the +X direction.

In the above embodiment, the frame 5, the first movable member 6, and the second movable member 7 are each biased by the coupling member 57 having the biasing member 573. However, the present disclosure is not limited thereto, and at least one of the frame 5, the first movable member 6, and the second movable member 7 may be biased using an elastic member such as a leaf spring, a wire spring, or rubber, and a magnet or the like.

Further, portions that bias the frame 5, the first movable member 6, and the second movable member 7 are not limited to the four corners of each configuration, but may be other locations, and the number of biasing locations may not be four.

Further, it is not necessary to bias each of the frame 5, the first movable member 6, and the second movable member 7 using a biasing member. For example, the frame 5 and the second movable member 7 that holds the projection optical device 36 may be biased by a biasing member, and the first movable member 6 interposed between the frame 5 and the second movable member 7 may not be biased.

In the above embodiment, the first movable member 6 moves along the +Y direction with respect to the frame 5, and the second movable member 7 moves along the +X direction with respect to the frame 5. However, the present disclosure is not limited thereto, and the first movable member 6 may move along the +X direction, and the second movable member 7 may move along the +Y direction.

Further, moving directions of the first movable member 6 and the second movable member 7 are not limited to the ±X direction and the ±Y direction, and may be directions inclined with respect to the ±X direction and the ±Y direction.

In the above embodiment, of the first movable member 6 and the second movable member 7, the second movable member 7 located on the emission side of image light holds the projection optical device 36. However, the present disclosure is not limited thereto, and the first movable member 6 may hold the projection optical device 36.

In the above embodiment, the shift device 4 includes the first movable member 6 and the second movable member 7 as the movable members that move the projection optical device 36. However, the number of the movable members is not limited thereto, and may be three or more.

In the above embodiment, the first feed screw 81 is given as the first drive unit that applies the first driving force to the first movable member 6, and the second feed screw 82 is given as the second drive unit that applies the second driving force to the second movable member 7. However, the present disclosure is not limited thereto, and the driving force may be applied to the movable members by a configuration other than a feed screw. For example, a lever may be employed for at least one of the first drive unit and the second drive unit, and the movable member may be moved by the lever.

The biasing member 813, 823 employed in the feed screw 81, 82 is not limited to the compression coil spring, and may be other spring member such as a leaf spring or a wire spring, or may be an elastic member such as rubber.

In the above embodiment, the rotational force of the dial D1 is transmitted to the first feed screw 81 by the gears 921 to 924 that form the first transmission unit 92, and the rotational force of the dial D2 is transmitted to the second feed screw 82 by the gears 931 to 933 that form the second transmission unit 93. However, the present disclosure is not limited thereto, and the number of gears that form each of the transmission units 92 and 93 may be appropriately changed.

In addition, each of the transmission units 92 and 93 is not limited to a configuration in which a rotational force is transmitted using gears, and for example, a pulley or the like may be used.

Further, one of the transmission units 92 and 93 may be omitted. In this case, one of the dials D1 and D2 may be directly coupled to one of the feed screws 81 and 82.

In the above embodiment, the biasing member 813 of the first feed screw 81 is provided between the first gear 811 and the second gear 812. That is, the biasing member 813 is sandwiched between the first gear 811 and the second gear 812. However, the present disclosure is not limited thereto, and for example, a configuration may be provided in which the biasing member 813 is held on the second attachment member 912, and the biasing member 813 biases an integrated configuration of the first gear 811 and the second gear 812 against the meshing members.

In the above embodiment, the first meshing member SM1 is fixed to the first movable member 6 by the screw SC, and the second meshing member SM2 is fixed to the second movable member 7 by the screw SC. However, the present disclosure is not limited thereto, and the first meshing member SM1 and the first movable member 6 may be integrated in an inseparable state. The same applies to the second meshing member SM2 and the second movable member 7.

In the above embodiment, the first feed screw 81 that applies the first driving force to the first movable member 6 and the third inner surface 523 that defines the moving end of the first movable member 6 in the +Y direction are located on opposite sides from each other in the +Y direction with the opening 51, 61 interposed therebetween when viewed from the ±Z direction. That is, the first feed screw 81 and the third inner surface 523 are located on opposite sides from each other in the +Y direction with the optical axis of the projection optical device 36 interposed therebetween. However, the present disclosure is not limited thereto, and the first feed screw 81 and the third inner surface 523 may be disposed on the same side with respect to the opening 51, 61 or the optical axis of the projection optical device 36 when viewed from the ±Z direction. The same applies to the second feed screw 82 that applies the second driving force to the second movable member 7, and the third inner surface 653 and the fourth inner surface 654 that define the moving ends of the second movable member 7 in the ±X directions.

In the above embodiment, in the orthogonal plane orthogonal to the optical axis of the projection optical device 36, the first feed screw 81 serving as the first drive unit, and the first guide pin 63 and the first guide groove 52 that form the first guide portion GD1 for guiding the movement of the first movable member 6 along the +Y direction are disposed on the imaginary straight line L1 along the +Y direction as the first direction orthogonal to the optical axis of the projection optical device 36. The first imaginary straight line L1 coincides with the rotation axis R×1 of the first feed screw 81. However, the present disclosure is not limited thereto, and the first imaginary straight line L1 and the rotation axis R×1 may not coincide with each other. In addition, the first feed screw 81 and the first guide portion GD1 for guiding the movement of the first movable member 6 along the +Y direction may not be disposed on the imaginary straight line L1.

The same applies to the second feed screw 82 serving as the second drive unit and the second guide portion GD2 that guides the movement of the second movable member 7 along the +X direction.

In the above embodiment, the first guide portion GD1 formed by the first guide pin 63 and the first guide groove 52 defines a movement range of the first movable member 6 along the +Y direction. However, the present disclosure is not limited thereto, and the first guide portion GD1 may only have a function of guiding the movement of the first movable member 6 along the +Y direction, and the movement range of the first movable member 6 along the +Y direction may be defined by a member separate from the first guide portion GD1. In this case, it is preferable that the separate member, together with at least a part of the first meshing portion SM11, be disposed on the same virtual plane VP1 orthogonal to the optical axis. The same applies to the second guide portion GD2.

In the above embodiment, the projector 1 includes the three light modulation devices 343R, 343G, and 343B. However, the present disclosure is not limited thereto, and may also be applied to a projector including two or less light modulation devices, or four or more light modulation devices.

In the above embodiment, the light modulation device 343 includes a transmissive liquid crystal panel having a light incident surface and a light emission surface that are different from each other. However, the present disclosure is not limited thereto, and the light modulation device 343 may include a reflective liquid crystal panel in which a light incident surface and a light emission surface are the same. Further, a light modulation device using any element other than a liquid crystal-based element, such as a device using micromirrors, for example, a digital micromirror device (DMD), may be employed as long as the element is capable of modulating an incident light flux to form an image according to image information.

### Summary of Present Disclosure

The present disclosure is summarized below as appendices.

### Appendix 1

A shift device that moves a projection optical device configured to project an image in a first direction orthogonal to an optical axis of the projection optical device, the shift device including:
a first movable member having a first reference portion and configured to move the projection optical device;
a frame movably supporting the first movable member;
a first drive unit configured to apply a first driving force to the first movable member to move the first movable member along the first direction; and
a first regulating surface configured to regulate movement of the first movable member along the first direction by coming into contact with the first reference portion, in which
the first movable member includes a first load region to which the first driving force acts from the first drive unit, and
the first regulating surface and at least a part of the first load region are disposed on a same first virtual plane orthogonal to the optical axis.

According to such a configuration, the first regulating surface and the first load region are disposed on the same first virtual plane, so that even when the first driving force is applied to the first load region and the first movable member moves along the first direction, it is possible to prevent the generation of the rotational moment that rotates the first movable member in the direction inclined with respect to an orthogonal plane orthogonal to the optical axis of the projection optical device. Therefore, it is possible to suppress a change in the focus position of an image projected by the projection optical device, and therefore, it is possible to prevent the deterioration of the image projected by the projection optical device.

### Appendix 2

In the shift device according to Appendix 1,
when one direction along the optical axis is defined as a first optical axis direction and a direction opposite to the first optical axis direction is defined as a second optical axis direction,
the first virtual plane is located between an end portion located closer to the second optical axis direction among an end portion of the first reference portion in the first optical axis direction and an end portion of the first regulating surface in the first optical axis direction, and an end portion located closer to the first optical axis direction among an end portion of the first reference portion in the second optical axis direction and an end portion of the first regulating surface in the second optical axis direction.

By positioning the first regulating surface and the first load region are located on the first virtual plane disposed at such a position, the generation of the rotational moment can be prevented. Therefore, a change in the focus position of an image projected by the projection optical device can be reduced, and the deterioration of the projected image can be prevented.

### Appendix 3

In the shift device according to Appendix 1 or Appendix 2,
the first reference portion, the first regulating surface, and at least a part of the first load region are disposed on an imaginary first straight line along the first direction.

According to such a configuration, the first reference portion can be brought into contact with the first regulating surface along the first direction in which the first driving force is applied to the first load region. Therefore, when the first reference portion is in contact with the first regulating surface, it is possible to prevent generation of not only the rotational moment that tilts the first movable member with respect to the optical axis orthogonal plane, but also the rotational moment that rotates the first movable member within the optical axis orthogonal plane. Therefore, the first movable member can be stably moved along the first direction, and thus the projection optical device can be stably moved along the first direction.

### Appendix 4

In the shift device according to Appendix 3,
the first drive unit is a feed screw that is provided on the frame in a manner of being rotatable about a rotation axis along the first direction and that applies the first driving force to the first movable member by rotating, and
the first straight line coincides with the rotation axis of the feed screw.

According to such a configuration, when the feed screw is rotated and the first movable member moves along the first direction, the generation of the rotational moment described above can be prevented.

### Appendix 5

In the shift device according to Appendix 4,
the feed screw includes
   a first gear to which a rotational force for rotating the feed screw is transmitted,
   a second gear configured to rotate integrally with the first gear, having helical teeth along the first direction on an outer peripheral surface, and meshing with the first movable member, and
   a biasing member provided between the first gear and the second gear and configured to bias the second gear in a direction away from the first gear along the first direction.

According to such a configuration, occurrence of rattling between the second gear and the first movable member can be prevented. In addition, since the biasing member is provided inside the feed screw, the size of the shift device along the first direction can be reduced as compared with a case in which the biasing member is provided at a position where the biasing force for maintaining a contact state between the second gear and the first movable member acts on the entire feed screw. Accordingly, the size of the shift device can be reduced.

### Appendix 6

The shift device according to any one of Appendices 1 to 5, further including:
a first guide portion configured to guide the movement of the first movable member along the first direction, wherein
the first guide portion includes
   a first guide pin provided on one of the first movable member and the frame, and
   a first guide groove provided on the other of the first movable member and the frame, extending in the first direction, and in which the first guide pin is disposed, and
the first guide pin is disposed in the first guide groove in a manner of being movable along the first direction.

According to such a configuration, the first movable member can be smoothly moved along the first direction by the first guide portion. In addition, since the first guide portion can be formed by the first guide pin and the first guide groove, the first guide portion can be simply formed.

### Appendix 7

In the shift device according to Appendix 6,
the first guide pin is provided in the first movable member,
the first guide groove is provided in the frame,
the first reference portion is the first guide pin, and
the first regulating surface is an inner surface of the first guide groove that intersects with the first direction.

According to such a configuration, compared to a case where the first reference portion is provided separately from the first guide pin and the first regulating surface is provided separately from the first guide groove, the configuration of the shift device can be simplified, and the size of the shift device in the first direction can be reduced.

### Appendix 8

In the shift device according to Appendix 6 or Appendix 7,
the frame has an opening through which the projection optical device is inserted, and
the first drive unit and the first guide portion are disposed on opposite sides from each other with the opening being interposed.

According to such a configuration, a distance between the first drive unit and the first guide portion can be increased. Therefore, as compared with a case where a distance between the first drive unit and the first guide portion is short, the linear movement stability of the first movable member can be improved.

### Appendix 9

The shift device according to any one of Appendices 1 to 8, further including:
a second movable member having a second reference portion and configured to move the projection optical device along a second direction orthogonal to the optical axis and the first direction;
a second drive unit configured to apply a second driving force to the second movable member to move the second movable member along the second direction; and
a second regulating surface configured to regulate movement of the second movable member along the second direction by coming into contact with the second reference portion, in which
the second movable member includes a second load region to which the second driving force acts from the second drive unit, and
the second regulating surface and at least a part of the second load region are disposed on a same second virtual plane orthogonal to the optical axis.

According to such a configuration, as with the first movable member, it is possible to prevent the generation of the rotational moment that rotates the second movable member in the direction inclined with respect to the orthogonal plane orthogonal to the optical axis of the projection optical device. Therefore, it is possible to suppress a change in the focus position of an image projected by the projection optical device, and therefore, it is possible to prevent the deterioration of the image projected by the projection optical device.

### Appendix 10

A projector including:
a light source;
a light modulation device configured to modulate light emitted from the light source;
a projection optical device configured to project light modulated by the light modulation device; and
the shift device according to any one of Appendices 1 to 9 configured to move the projection optical device.

Such a projector can achieve the same effects as those of the shift device described above, so that the projection optical device can be shifted stably and degradation of a projected image can be prevented.

What is claimed is:

1. A shift device that moves a projection optical device in a first direction orthogonal to an optical axis of the projection optical device, the projection optical device being configured to project an image, the shift device including:
a first movable member having a first reference portion and configured to move the projection optical device;
a frame movably supporting the first movable member;
a first drive unit configured to apply a first driving force to the first movable member to move the first movable member along the first direction; and
a first regulating surface configured to regulate movement of the first movable member along the first direction by coming into contact with the first reference portion, in which
the first movable member includes a first load region to which the first driving force acts from the first drive unit, and
the first regulating surface and at least a part of the first load region are disposed on a same first virtual plane orthogonal to the optical axis.

2. The shift device according to claim 1, wherein
when one direction along the optical axis is defined as a first optical axis direction and a direction opposite to the first optical axis direction is defined as a second optical axis direction,
the first virtual plane is located between an end portion located closer to the second optical axis direction among an end portion of the first reference portion in the first optical axis direction and an end portion of the first regulating surface in the first optical axis direction, and an end portion located closer to the first optical axis direction among an end portion of the first reference portion in the second optical axis direction and an end portion of the first regulating surface in the second optical axis direction.

3. The shift device according to claim 1, wherein
the first reference portion, the first regulating surface, and at least a part of the first load region are disposed on an imaginary first straight line along the first direction.

4. The shift device according to claim 3, wherein
the first drive unit is a feed screw that is provided on the frame in a manner of being rotatable about a rotation axis along the first direction and that applies the first driving force to the first movable member by rotating, and
the first straight line coincides with the rotation axis of the feed screw.

5. The shift device according to claim 4, wherein
the feed screw includes
a first gear to which a rotational force for rotating the feed screw is transmitted,
a second gear configured to rotate integrally with the first gear, having helical teeth along the first direction on an outer peripheral surface, and meshing with the first movable member, and
a biasing member provided between the first gear and the second gear and configured to bias the second gear in a direction away from the first gear along the first direction.

6. The shift device according to claim 1, further comprising:
a first guide portion configured to guide the movement of the first movable member along the first direction, wherein
the first guide portion includes
a first guide pin provided on one of the first movable member and the frame, and
a first guide groove provided on the other of the first movable member and the frame, extending in the first direction, and in which the first guide pin is disposed, and
the first guide pin is disposed in the first guide groove in a manner of being movable along the first direction.

7. The shift device according to claim 6, wherein
the first guide pin is provided in the first movable member,
the first guide groove is provided in the frame,
the first reference portion is the first guide pin, and
the first regulating surface is an inner surface of the first guide groove that intersects with the first direction.

8. The shift device according to claim 6, wherein
the frame has an opening through which the projection optical device is inserted, and
the first drive unit and the first guide portion are disposed on opposite sides from each other with the opening being interposed.

9. The shift device according to claim 1, further comprising:
a second movable member having a second reference portion and configured to move the projection optical device along a second direction orthogonal to the optical axis and the first direction;
a second drive unit configured to apply a second driving force to the second movable member to move the second movable member along the second direction; and
a second regulating surface configured to regulate movement of the second movable member along the second direction by coming into contact with the second reference portion, wherein
the second movable member includes a second load region to which the second driving force acts from the second drive unit, and
the second regulating surface and at least a part of the second load region are disposed on a same second virtual plane orthogonal to the optical axis.

10. A projector comprising:
a light source;
a light modulation device configured to modulate light emitted from the light source;
a projection optical device configured to project light modulated by the light modulation device; and
the shift device according to claim 1 configured to move the projection optical device.
